(19) United States
(12) Patent Application Publication
(10) Pub. No.: US 2010/0306175 A1
(43) Pub. Date: Dec. 2, 2010

(54) FILE POLICY ENFORCEMENT

(75) Inventors: Rodd Eric Johnson, Chaska, MN (US); Kenneth M. Peters, Woodbury, MN (US); Brad D. Wenzel, Mahtomedi, MN (US)

Correspondence Address: SHUMAKER & SIEFFERT, P. A., 1625 RADIO DRIVE, SUITE 300, WOODBURY, MN, 55125, US

(73) Assignee: Digitiliti, Inc., St. Paul, MN (US)

(21) Appl. No.: 12/695,081

(22) Filed: Jan. 27, 2010

Related U.S. Application Data
(60) Provisional application No. 61/206,145, filed on Jan. 28, 2009.

(51) Int. Cl. G06F 17/30

(52) U.S. Cl. 707/663; 707/E17.01

(57) ABSTRACT

Policies are associated with files according to a number of criteria, for example, a file type and a user who created the file. Policies may control when a file can be deleted. In one example, a device includes a computer-readable medium configured to store a file, and a processing unit configured to determine a time of retention for the file specified by a policy associated with the file, receive a request to delete the file, and delete the file in response to the request only after the time of retention for the file specified by the policy has passed. In addition, a file may be subject to a legal hold that prevents the file from being deleted even after the time of retention has passed. Similarly, while a user stores a link to the file, the device may prevent the file from being deleted.

This application claims the benefit of U.S. Provisional Application No. 61/206,145, filed Jan. 28, 2009, which is incorporated herein by reference in its entirety.

### TECHNICAL FIELD

This disclosure relates to electronic and computerized data storage and retrieval.

### BACKGROUND

Storage of computer data has become important for various entities, such as businesses, for a variety of reasons. Regulatory agencies require certain data to be backed up for periods of time. Laws and regulations may require minimum retention periods for records such as contracts, business records, employee records, payroll records, and other records. The Sarbanes-Oxley Act, for example, imposes demanding data security and accessibility requirements on corporate information. The Health Insurance Portability and Accountability Act, as another example, includes strict requirements for data integrity and protection. Other regulations impacting data retention include the Gramm-Leach-Bliley Act, the Federal Rules of Civil Procedure, the California Codes Information Practices Act, and the European Union Data Protection Directives.

Businesses, individuals, and organizations may choose to retain data such as business records for a period of time as well, e.g., in order to recover from a loss of data for a particular business site. An average North American enterprise stores 59 terabytes worth of data, with a projected annual growth of 20 to 30 percent. Conventional methods of data backup are expensive, costing an average enterprise over $300 per gigabyte of data.

Nearly 70 percent of enterprise data is backed up using magnetic tape-based data cartridges or disks. After data has been saved to a data cartridge, the entity may store the cartridge locally or at a remote facility. This can lead to cartridges becoming lost or stolen. The magnetic tape can also be damaged from mishandling or improper storage of the cartridge, for example, when the cartridge is dropped. Also, over time, magnetic tape can degrade or corrode, sometimes leading to data loss. In addition, the data stored to magnetic tape is only accessible to those who have access to the data cartridge. Thus, when data cartridges are stored remotely, access to the data stored on the cartridges may be limited.

For most entities, over 80 percent of files that are periodically backed up remain unchanged. Nevertheless, it remains common practice to re-save each of these unchanged files in the backup. This results in backups becoming duplicative many times over, thus causing a tremendous amount of repetitive backups and unnecessary cost.

### SUMMARY

In general, a data storage system is described that automatically archives and retains data, in the form of structured information objects, in various locations, transparently to users of the system. A user interacts with an endpoint device of the system, while a director device enforces policies throughout the system. When a user attempts to store a file to the endpoint device, the file may actually be stored to the director device and/or the director archive in the form of an information object that the endpoint device automatically creates, transparently to the user. The endpoint device may store a link to the information object that appears to the user as if the file is stored in the location where the user stored the information object. In general, an information object may comprise the file, Policy information, as well as metadata that is automatically appended to the file by the endpoint device.

The director device may also enforce policies based on the information object, a file type for the information object, a user's access privileges, a group to which the user belongs, or other elements. The policies may include, for example, whether to allow a user to read and/or write an information object, whether to allow a user to write an information object to a particular location, e.g., to external media such as a thumb drive, whether to allow a user to delete an information object, whether and how to encrypt an information object, and/or whether and how to compress an information object.

By storing links to information objects on an endpoint device while storing the actual data for the information object at the director device, the director device may reduce duplicate storage throughout a computer network. For example, when two or more users attempt to save the same information object, the director device may detect that each of the users are attempting to store the same information object. Therefore, the director device may store a single copy of the information object, and each endpoint device for each user may store a respective link to the information object.

The director device may further track accesses to particular information objects, e.g., to perform revision control. The director device may maintain a log of all accesses to each information object, such as an identifier for the user who accessed the information object, a date/time at which the information object was accessed, and whether the user modified the information object. The director device may further store a number of revisions of a particular information object, e.g., by object type, by individual, group, or global user setting, such that a user may view revisions made to the information object over time. In addition, the director device may enforce policy, such as data access policy, data retention policy, data deletion policy, or other information management policy, and this enforcement of policy may be transparent to the endpoint devices.

In one example, a method includes determining, with a computing device, a file type for a file to be stored, wherein the file comprises an unstructured data object, automatically appending, with the computing device, metadata to the file to create an information object based on the determined file type, wherein an information object comprises a structured data object having a structure that is consistent with a uniform structure for files as used by a director device, sending, with the computing device, the information object to the director device for storage and/or archiving, and storing, with the computing device, a link to the information object stored by the director device.

In another example, a method includes determining, with a director device, a file type for a file to be stored, wherein the file comprises an unstructured data object, automatically appending, with the director device, metadata to the file to create an information object based on the determined file type, wherein an information object comprises a structured data object having a structure that is consistent with a uniform structure for files as used by the director device, and storing and/or archiving, with the director device, the information object.

In another example, an endpoint device includes a processing unit configured to determine a file type for a file to be stored, wherein the file comprises an unstructured data object, and automatically append metadata to the file to create an information object based on the determined file type, wherein an information object comprises a structured data object having a structure that is consistent with a uniform structure for files as used by a director device, and a network interface configured to send the information object to the director device for storage and/or to the director archive for archiving, wherein the processing unit is configured to store a link to the information object stored by the director device.

In another example, a system includes a director device comprising a computer-readable storage medium, wherein the director device is configured to store information objects in the computer-readable storage medium that conform to a uniform structure, and an endpoint device comprising a processing unit configured to determine a file type for a file to be stored, wherein the file comprises an unstructured data object, and automatically append metadata to the file to create an information object based on the determined file type, wherein the information object conforms to the uniform structure of the director device, and a network interface configured to send the information object to the director device for storage and/or to the director archive for archiving, wherein the processing unit is configured to store a link to the information object stored by the director device.

In another example, a computer-readable storage medium stores instructions that cause a processor of an endpoint device to determine a file type for a file to be stored, wherein the file comprises an unstructured data object, automatically append metadata to the file to create an information object based on the determined file type, wherein an information object comprises a structured data object having a structure that is consistent with a uniform structure for files as used by a director device, cause a network interface of the endpoint device to send the information object to the director device for storage and/or to the director archive for archiving, and store a link to the information object stored by the director device.

In another example, a computer-readable storage medium stores instructions that cause a processor of a director device to determine a file type for a file to be stored, wherein the file comprises an unstructured data object, automatically append metadata to the file to create an information object based on the determined file type, wherein an information object comprises a structured data object having a structure that is consistent with a uniform structure for files as used by the director device, and store the information object, e.g., in the information director and/or director archive.

In another example, a method includes storing, by a computing device, a file received from a first endpoint device, storing, by the computing device, an updated version of the file received from a second endpoint device without overwriting an original version of the file as received from the first endpoint device, in response to receiving a request for the file from the first endpoint device, sending, by the computing device, the original version of the file to the first endpoint device, and, in response to receiving a request for the file from the second endpoint device, sending, by the computing device, the updated version of the file to the second endpoint device.

In another example, a computing device includes a network interface configured to communicate with a first endpoint device and a second endpoint device, a computer-readable medium, and a processing unit. The processing unit may be configured to store a file received from the first endpoint device in the computer-readable medium, store an updated version of the file received from the second endpoint device without overwriting an original version of the file as received from the first endpoint device. In response to receiving a request for the file from the first endpoint device, the processing unit may be configured to send the original version of the file to the first endpoint device. In response to receiving a request for the file from the second endpoint device, the processing unit may be configured to send the updated version of the file to the second endpoint device.

In another example, a system includes a first endpoint device, a second endpoint device, and a director device configured to store a file received from the first endpoint device, store an updated version of the file received from a second endpoint device without overwriting an original version of the file as received from the first endpoint device. When the first endpoint device requests the file, the director device is configured to send the original version of the file to the first endpoint device. When the second endpoint device requests the file, the director device is configured to send the updated version of the file to the second endpoint device.

In another example, a computer-readable storage medium is encoded with instructions that cause a processor to store a file received from a first endpoint device, store an updated version of the file received from a second endpoint device without overwriting an original version of the file as received from the first endpoint device in response to receiving a request for the file from the first endpoint device, send the original version of the file to the first endpoint device, and, in response to receiving a request for the file from the second endpoint device, send the updated version of the file to the second endpoint device.

In another example, a method includes determining, by a computing device, a time of retention for a file specified by a policy associated with the file, receiving a request to delete the file, and deleting the file only after the time of retention for the file specified by the policy has passed. Deleting the file may further include deleting the file only after authorized user(s) have approved the file for deletion.

In another example, a device includes a computer-readable medium configured to store a file, and a processing unit configured to determine a time of retention for the file specified by a policy associated with the file, receive a request to delete the file, and delete the file in response to the request only after the time of retention for the file specified by the policy has passed. The processing unit may also delete the file only after authorized user(s) have approved the file for deletion.

In another example, a system includes a plurality of endpoint devices, and a director device configured to determine a time of retention for a file specified by a policy associated with the file, wherein the file is stored by the director device, receive a request to delete the file from one of the plurality of endpoint devices, and delete the file in response to the request only after the time of retention for the file specified by the policy has passed. The director device may further delete the file only after authorized user(s) have approved the file for deletion.

In another example, a computer-readable storage medium is encoded with instructions that cause a processor to determine a time of retention for a file specified by a policy associated with the file, receive a request to delete the file, and delete the file in response to the request only after the time of retention for the file specified by the policy has passed. The instructions may further cause the processor to delete the file only after authorized user(s) have approved the file for deletion.

In another example, a method includes generating, by a director archive device, a list of identifiers of one or more files stored by the director archive device that should be removed from a director device in accordance with policies of the respective one or more files, wherein the director archive device stores copies of files stored by the director device, and wherein the director device is communicatively coupled to the director archive device, and sending the list of identifiers to the director device to cause the director device to delete the one or more files from local storage of the director device.

In another example, a director archive device includes a processing unit configured to generate a list of identifiers of one or more files stored by the director archive device that should be removed from a director device in accordance with policies of the respective one or more files, wherein the director archive device is configured to store copies of files stored by the director device, and wherein the director device is communicatively coupled to the director archive device, and a network interface configured to send the list of identifiers to the director device to cause the director device to delete the one or more files from local storage of the director device.

In another example, a system includes a director device configured to store a plurality of files, and a director archive device communicatively coupled to the director archive device comprising a computer-readable medium configured to store copies of the plurality of files stored by the director device, a processing unit configured to generate a list of identifiers of one or more files stored by the director archive device that should be removed from the director device in accordance with policies of the respective one or more files, and a network interface configured to send the list of identifiers to the director device to cause the director device to delete the one or more files from local storage of the director device.

In another example, a computer-readable storage medium encoded with instructions that cause a processor of a director archive device to generate a list of identifiers of one or more files stored by the director archive device that should be removed from a director device in accordance with policies of the respective one or more files, wherein the director archive device stores copies of files stored by the director device, and wherein the director device is communicatively coupled to the director archive device, and send the list of identifiers to the director device to cause the director device to delete the one or more files from local storage of the director device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system in which a plurality of computing devices store data to one or more director through a plurality of corresponding accelerators.

FIG. 2 is a block diagram illustrating elements of an example information object.

FIG. 3 is a block diagram illustrating components of an example endpoint device.

FIG. 4 is a block diagram illustrating an example arrangement of components of a director device.

FIG. 5 is a flowchart illustrating an example process for storing an information object by an endpoint device.

FIG. 6 is a flowchart illustrating an example process for handling delete requests from a user for a particular file.

FIG. 7 is a flowchart illustrating an example process for an endpoint device to open and update a file stored by a director device.

FIG. 8 is a flowchart illustrating an example process for performing either or both of encryption and compression by a director device after a new file has been stored.

FIG. 9 is flowchart illustrating an example method of file revision control for a system including a plurality of endpoint devices and a director device.

FIG. 10 is a flowchart illustrating an example deduplication procedure between a director archive and a director device.

### DETAILED DESCRIPTION

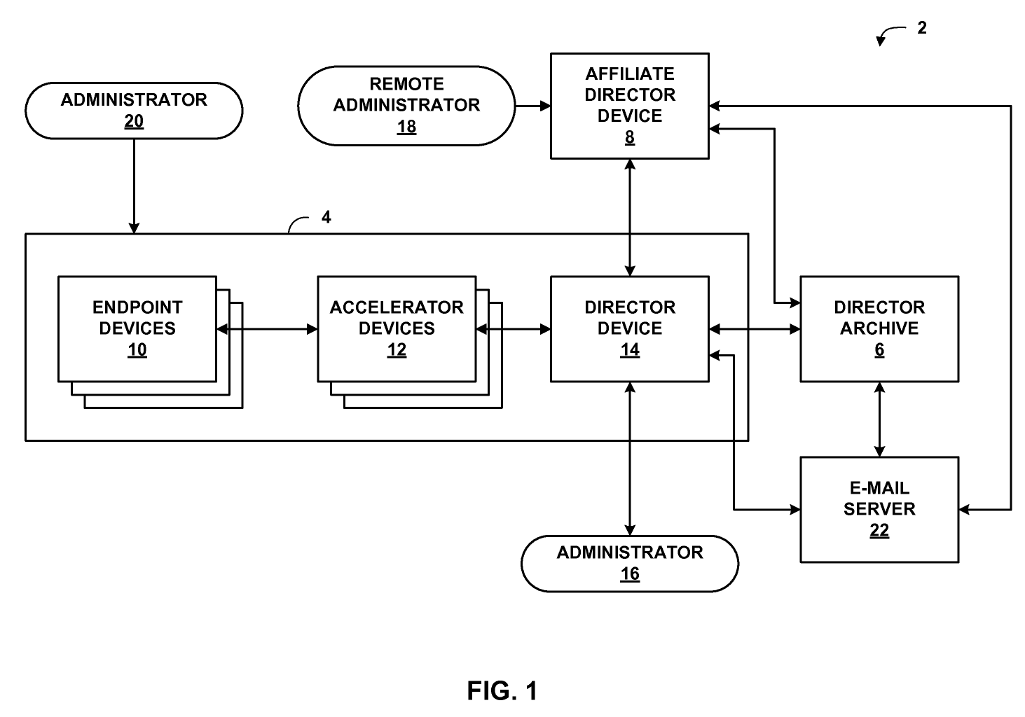

FIG. 1 is a block diagram illustrating example system 2 in which endpoint devices 10 store data to director device 14 through respective accelerator devices 12. In the example of FIG. 1, region 4 includes endpoint devices 10, accelerator devices 12, and director device 14. System 2 also includes affiliate director device 8, director archive 6, and e-mail server 22. Director archive 6 may also be referred to herein as a vault, as director archive 6 generally stores data for a plurality of director devices, such as director device 14 and affiliate director device 8. Endpoint devices 10, accelerator devices 12, director device 14, affiliate director device 8, director archive 6, and e-mail server 22 may each comprise respective computing devices, which may each generally include computer-readable media and one or more processors. The computer-readable media may comprise (e.g., be encoded with) instructions for causing the one or more processors to perform the functions attributed to the respective devices, modules, and/or units, as described in this disclosure.

In general, data storage, retrieval, and manipulation activities are driven by policies, e.g., definitions of who is allowed to access, store, and/or retrieve data within system 2. In the discussion below, features attributed to any device of system 2 may be modified, configured, overridden, or otherwise modified by adjusting corresponding policies. For example, a particular user, a group having one or more users, or a combination of users and/or groups may be granted privileges to override policy-driven activities. The use of policies to control elements of system 2 is described in greater detail below.

In the example of FIG. 1, endpoint devices 10, accelerator devices 12, and director device 14 are communicatively coupled, e.g., in a wired, wireless, of fiber-optic fashion by a computer network, the Internet, an intranet, or by other means. System 2 may correspond to a business entity, a corporate entity, a government entity, a nonprofit entity, or an enterprise generally. Region 4 corresponds to one region for the enterprise, e.g., a particular location, facility, or campus of the enterprise. Director device 14 may also interact with affiliate directors, such as affiliate director device 8, which may be part of the same enterprise but located at a physically remote region, separate from region 4. Director archive 6 and e-mail server 22 may form part of the same enterprise, or in some examples, may provide services to additional enterprises.

In general, endpoint devices 10 may comprise computing devices for use by users of system 2, e.g., employees. For example, endpoint devices 10 may comprise personal computers, thin-client terminals, mobile devices such as cellular telephones or personal digital assistants (PDAs), laptop computers, notebook computers, tablet computers, or any other computing device that would typically interact with a network. Director device 14 stores data for each of endpoint devices 10, to serve as a shared data repository and data archive. Director device 14 may also store directories for each user of region 4. That is, a directory structure may be stored both by the endpoint device and by director device 14, such that the directory structure may be recovered if it is lost or damaged on the endpoint device, or if the user logs into a different endpoint device. As discussed in greater detail below, director device 14 also performs many other functions for system 2. For example, director device 14 may enforce policies with respect to data stored in system 2, where the policies may include data access privileges including read and write privileges, data deletion and retention control, encryption, and/or compression.

Administrator 16 generally configures director device 14 and policies thereof, and administrator 20 configures and maintains devices of region 4, while remote administrator 18 configures affiliate director device 8 and policies thereof. Although three individual administrators are shown in the example of FIG. 1 for purposes of example, there may be more or fewer administrators. Similarly, certain users may be granted administrator privileges, in some examples.

When a user attempts to store a file to a respective one of endpoint devices 10, the file may in fact be stored to director device 14, transparently to the user. The endpoint device may store a link to the file that appears to the user as the file itself. The endpoint device may store the link in a directory, and the directory and link may also be stored to director device 14. That is, from the user's perspective, the file may appear to be stored in the location where the user stored the file on the user's endpoint device. However, the actual data for the file may be stored at director device 14. In this manner, director device 14 may enforce policies with respect to various files, as described in greater detail below.

In the example of FIG. 1, each of endpoint devices 10 interfaces with one of accelerator devices 12. Similarly, each of accelerator devices 12 is coupled to one or more endpoint devices 10. In some examples, one or more of endpoint devices 10 may also be coupled directly to director device 14, without being coupled to an intermediate accelerator device 12. Each of accelerator devices 12 stores data from the corresponding ones of endpoint devices 10 and transmits the data to director device 14. Accelerator devices 12 may also retrieve data stored to director device 14 for corresponding ones of endpoint devices 10. In general, accelerator devices 12 may cache data stored in endpoint devices 10 and retrieved from director device 14. In effect, each of accelerator devices 12 may, from the perspective of an endpoint device, act like a director device, and from the perspective of a director device, act like an endpoint device.

Director device 14 generally acts as the primary storage facilities for data storage of region 4 of the enterprise of system 2. Director device 14 may store hundreds of gigabytes, multiple petabytes or even multiple exabytes of data. As data storage capabilities increase, the amount of storage space available on director device 14 may increase, such that the amount of data director device 14 is capable of storing may perpetually increase. In one example, director device 14 stores copies of all of the files stored on accelerator devices 12 and endpoint devices 10, and all dormant files, therefore director device 14 stores copies of all files stored within region 4 of the enterprise. Director device 14 may store, for example, operating system code, dynamically linked libraries (DLLs), and other system software or executable files.

In one example, one or more of endpoint devices 10 may retrieve an operating system from director device 14 and may boot the operating system without a user having installed the operating system on the one of endpoint devices 10. In some examples, endpoint devices 10 may retrieve and/or execute applications from director device 14 without a user having installed the application on the endpoint device. In this manner, any or all of endpoint devices 10 may act as thin client computing devices that include sufficient hardware, firmware, and software to become active and to communicate with director device 14, and then to execute programs stored by director device 14. Any or all of endpoint devices 10 may also comprise general purpose computing devices that execute programs stored by director device 14 when necessary.

In one example, endpoint devices 10 store files locally for a period of time while the files are considered “active.” Accelerator devices 12 may also store all of the files of corresponding ones of endpoint devices 10, as well as all “inactive” files. Director device 14 may store an archive of files no longer stored on endpoint devices 10 and/or accelerator devices 12, i.e., “dormant” files. For example, director device 14 may store particular files for a period of time corresponding to a time for retention, e.g., as required by laws or regulations governing a business's data retention. Director device 14 also enforces one or more policies for file retention on endpoint devices 10 and accelerator devices 12. That is, director device 14 causes endpoint devices 10 to delete files after a first period of time and accelerator devices 12 to delete the files after a second period of time. In other examples, files may be stored directly to director device 14, without being stored to endpoint devices 10 for an “active” period.

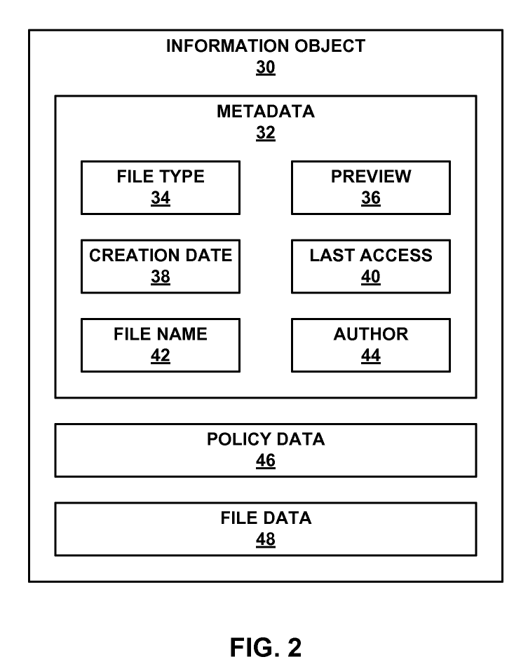

In general, system 2 utilizes information objects, as opposed to standard files, as data units that are transferred and stored within system 2 and utilized by entities of system 2, such as endpoint devices 10, accelerator devices 12, and director device 14. That is, endpoint devices 10, accelerator devices 12, and/or director device 14 add metadata to a file to create an information object. It should be understood that where this disclosure refers to files, the term “information objects” could also apply, unless otherwise noted. That is, where this disclosure refers to files, this disclosure more generally refers a standard file with the addition of metadata, as described in greater detail below, e.g., with respect to FIG. 2. The endpoint device may automatically add the metadata to the file to create the information object, transparently to the user.

When not affiliated with an information object, a file or other data may be referred to in this disclosure as “unstructured data.” In general, unstructured data does not include a structured representation, such as a standard formulation of metadata, as opposed to information objects of this disclosure. That is, information objects generally include a minimal set of metadata, such as, for example, an identifier of a creator/author of the data and an identifier of a computing device used to create the data. For purposes of further definition, an INFORMATION OBJECT may correspond to a uniformly formatted representation of otherwise disparate data type (Multipurpose Internet Mail Extension (MIME) types) and emails. These information objects can be accessed and analyzed with search engines and information applications via standard application programming interfaces (API's). Director devices common to an enterprise, such as director device 14 and affiliate director device 8, may generally use a uniform structure for all files and data objects, regardless of the file type of the data objects. For example, the organization may use a uniform structure for text documents, e-mail messages, image documents, video data, spreadsheet documents, presentation documents, drawings, or any other data.

Metadata for an information object may include any or all of a user identifier, a filesize value, a full file name, a last-modified date, file attributes, a machine identifier corresponding to the one of endpoint devices 10 used to create the file, a security identifier, a security descriptor, a file MIME-type identifier, a creation date, and/or a last access date. In addition, the metadata for an e-mail information object may include an e-mail file identifier, a user role in the e-mail (e.g., sender, receiver), a number of attachments, a subject value, a “to” list that identifies to whom the e-mail was sent, a “from” or sender value that identifies the sender, and/or a “CC” list that identifies parties who were e-mail carbon copied on the e-mail. Individual administrators may further add, remove, or modify metadata elements at their discretion.

As shown in FIG. 1, an enterprise may include a plurality of directors, e.g., director device 14 local to region 4 and affiliate director device 8 at remote regions but still part of the same enterprise. Each of the director devices may be stored in different locations, such that physical destruction of a storage facility for one of the directors does not result in complete data loss. Each of the directors may also be stored on separate racks, within separate rooms of a storage facility, or otherwise be isolated or spatially separated from each other. In general, director devices of the same enterprise store data for respective regions of the enterprise. For example, director device 14 may store data for region 4 of the enterprise in system 2. In some examples, a subset of each of the directors may store identical data images, such that each of the directors of the subset stores the same data as each of the other directors in the subset. The directors may, for example, be divided into pairs, where each of the two directors of a pair stores identical data images, but where a first pair stores a distinct data image from a second pair of directors. In this manner, two or more directors may conform to a Redundant Array of Independent Disks (RAID) storage scheme such that two or more of director device 14 are in a RAID array.

Files and information objects stored by the directors may also be stored in a RAID array on a plurality of directors, such that even a failure of two directors does not cause a complete loss of data. Each of the plurality of directors may also store unique data. In any case, director device 14 generally stores data from endpoint devices 10 for a long-term time period. For example, director device 14 may store a data set for a number of years or even permanently. Director device 14 may be arranged according to a database paradigm, as opposed to a file system paradigm. Director device 14 may therefore present a virtual file system to endpoint devices 10. In one example, director device 14 stores information objects in a database that includes the files as information objects, locations of each of the information objects, metadata to describe the information objects, and other information. The database may therefore store content for director device 14 without regard for location.

In some examples, a policy of director device 14 dictates a file-level RAID procedure. That is, the policy may dictate that certain files must be stored a minimum number of times at different locations at the same hierarchical level. For example, system 2 may include three director devices, a primary director device 14 and two mirrored directors. The policy of director device 14 may dictate that a first file is to be stored at a minimum of two directors, a second file is to be stored at all three directors, and a third file is to be stored at a minimum of one director. The third file may be stored at all three directors, but need not be to satisfy the policy. However, the first file must be stored in at least two of the directors, and the second file must be stored at all three directors, in order to satisfy the policy. A user, such as administrator 16, administrator 20 or remote administrator 18, may establish such a policy for a file based upon the file's importance and sensitivity to risk of loss for the company, or based on other factors. The policy may also dictate file category level RAID, in which files of a first category are stored at a first number of locations, and files of a second category are stored at a second number of locations, in accordance with the policy.

Director device 14 may also interface with an outside system that includes a data storage facility, such as director archive 6. For example, director device 14 may interface with director archive 6 of an outside system by communicating over a network, and data stored in director device 14 may be duplicated or relocated to director archive 6. Director archive 6 may store data for a plurality of enterprises, businesses, or other entities. Director device 14 may also encrypt any data sent to director archive 6. In some examples, data may be encrypted and/or compressed when stored on director device 14, in which case the data may be stored to director archive 6 without further encryption, although further encryption may be performed if required or desired.

Endpoint devices 10 may comprise, for example, laptop computers, workstation computers, desktop computers, hand-held devices such as personal digital assistants (PDAs), notebook computers, tablet computers, digital paper, or other computing devices. Endpoint devices 10 generally present a virtual file system to users thereof. In accordance with the techniques described herein, when a user or other entity (e.g., a software process executing on one of endpoint devices 10) stores a file by writing data to a storage medium of one of endpoint devices 10, e.g., by creating, downloading, retrieving, or otherwise obtaining a file that is stored to the storage medium of the one of endpoint devices 10, the data is replicated onto the accelerator corresponding to the one of endpoint devices 10 on which the user is working, as well as to director device 14. In some examples, a file is detected when a save or close file event is received by an operating system kernel. When a user of one of endpoint devices 10 stores a new file, the new file is stored within director device 14, and a link to the file is stored on the one of endpoint devices 10. In this context, a new file comprises a file that is not stored on director device 14.

In general, director device 14 may enforce policies to control where a new file is stored. For example, a policy may state that audio files, such as music files, may be stored directly to endpoint devices 10 without being copied or stored to director device 14, while word processing documents and spreadsheet documents may only be stored to director device 14. Accordingly, when a user attempts to store an audio file, such as an MP3, to the user's endpoint device, the endpoint device may store the actual file, whereas when the user attempts to store a word processing document, the endpoint device may send the document to director device 14 for storage, while the endpoint device stores a link to the document that appears to the user as if the document is stored on the endpoint device.

When a user of one of endpoint devices 10 receives, creates, or otherwise stores a file, the endpoint device may determine whether the file is a new file. For example, the endpoint device may query director device 14 with the file to determine whether the file is new. In one example, the endpoint device may send the file to director device 14 to determine whether the file is new. In another example, the endpoint device may execute one or more hash functions, such as a secure hash algorithm (SHA), a Message-Digest algorithm five (MD5) hash, or other conventional hash functions, and/or a combination thereof, on the file to produce a file signature and then send the file signature to director device 14 to determine whether the file is new. When the file is new, the endpoint device may automatically, transparently to the user, create an information object including the file, and then send the information object to director device 14, which may store the information object and the file signature. When the file is not a new file, the endpoint device may instead store a link to the file stored by director device 14, although the endpoint device may cause the link to the file to appear to a user as if the file is stored locally on the endpoint device.

Director device 14 is also configured to enforce policies with respect to information objects. In some examples, director device 14 may enforce policies to ensure compliance by endpoint devices 10, even when endpoint devices 10 are configured to enforce the same policies. In some examples, director device 14 may be configured to enforce a set of policies that endpoint devices 10 are not configured to enforce, e.g., to entirely block access by one or more of endpoint devices 10 to one or more information objects, to update software for endpoint devices 10, or to update policies of endpoint devices 10.

In one example, an information object can exist in one of three statuses: “active,” “inactive,” or “dormant.” A policy enforced by director device 14 may dictate when the status of a particular file changes from active to inactive and from inactive to dormant, as well as from dormant to active. Administrator 20, administrator 16, and/or remote administrator 18 may configure the policy for status changes for the file. As one example, administrator 20 may establish the policy for status changes as follows: 1) all new files are to be in “active” status; 2) when an “active” file has not been accessed by any user for 30 days, the file is to be given “inactive” status; 3) when an “inactive” file has not been accessed by any user for 180 days, the file is to be given “dormant” status; 4) when any file is accessed, the file is to be given “active” status and the 30 day timer is to be reset for the file. In this example, active files are stored at an endpoint device, an accelerator device, and director device 14, inactive files are stored only at the accelerator device and director device 14, and dormant files are stored only at director device 14.

The time periods during which data remain stored in endpoint devices 10 and accelerator devices 12 may vary by file type. Administrator 20, for example, may customize the policy of director device 14 to specify categories of files, and the periods of time that particular categories of files remain “active,” “inactive,” and “dormant” may vary by category. For example, administrator 20 may specify that text files are to remain “active” for 30 days and “inactive” for 120 days, video files are to remain “active” for 5 days and “inactive” for 25 days, and audio files are to remain “active” for 10 days and “inactive” for 45 days. Categorization of files for the purpose of the policy may be based on other properties of files as well, such as files that include particular metadata elements, sizes of the files, users who created the files, or other elements of the files. Policies may also dictate types of files that are to be stored at accelerator devices 12 and director device 14. For example, a policy may be configured that text files are to be copied to a respective one of accelerator devices 12 and director device 14, but movie and music files are not to be copied when stored on one of endpoint devices 10.

Files with a status of “active” are stored on the endpoint devices 10 that accessed the file, as well as the one of accelerator devices 12 corresponding to the endpoint devices 10, and on director device 14. When an “active” file becomes “inactive”, the file is removed from the storage media of all of endpoint devices 10 that stored the active file, but the file continues to be stored on the one of accelerator devices 12 and on director device 14. When an “inactive” file becomes “dormant,” the file is removed from accelerator devices 12 and is stored only on director device 14. When a user of one of endpoint devices 10 accesses a file, the file is immediately placed into “active” status, stored on a storage medium of the one of endpoint devices 10, and stored within the one of accelerator devices 12 corresponding to the one of endpoint devices 10 through which the user accessed the file. An administrator may configure a policy to allow one or more of endpoint devices 10 to store files locally, or to cause files for a particular user to be stored only to accelerator devices 12, director device 14, and/or director archive 6, but not on a local one of endpoint devices 10 for the user.

Director device 14 controls the flow of data from endpoint devices 10 to accelerator devices 12 and to director device 14 in accordance with the policy configured by administrator 20. Director device 14 includes indications of one or more locations where each file within system 2 is stored. Therefore, when a user of one of endpoint devices 10 attempts to access a particular file, the one of endpoint devices 10 first queries director device 14, transparently to the user, to determine the most upstream location of the file. That is, director device 14 may cause the one of endpoint devices 10 to act according to an “open closest file first” algorithm, where the one of endpoint devices 10 opens the copy of the file at the closest location at which the file is stored (e.g., in order of preference: first, the one of endpoint devices 10, second, the corresponding one of accelerator devices 12, third, director device 14, and fourth, director archive 6). In some examples, the open closest file first algorithm may cause one of endpoint devices 10 to open a file from a neighboring one of endpoint devices 10

For example, a user of one of endpoint devices 10 may request access to “example.pdf.” The one of endpoint devices 10 may request access to “example.pdf” from director device 14. “Example.pdf” may be an “inactive” file that is stored on accelerator 12. Therefore, director device 14 may inform the one of endpoint devices 10 that “example.pdf” is stored on accelerator 12, and the one of endpoint devices 10 may request access to “example.pdf” from accelerator 12. Accelerator 12 may then provide “example.pdf” to endpoint device 10. Director device 14 also records the fact that “example.pdf” now has an “active” status and that “example.pdf” is stored on the one of endpoint devices 10. The user of the one of endpoint devices 10 need not ever know where a particular file is actually stored, however, as this entire process occurs without the knowledge of the user.

From the perspective of the one of endpoint devices 10, the one of endpoint devices 10 may be configured to assume that a query for a location of a requested file is issued directly to director device 14. However, in reality, the one of endpoint devices 10 may issue the query to director device 14 through the corresponding one of accelerator devices 12. For example, one of endpoint devices 10 may issue a query to director device 14 to determine the location of “example.pdf.” Although the one of endpoint devices 10 may believe that it is interacting directly with director device 14, the query may actually be first issued to accelerator 12, which passes the query to director device 14, receives the result of the query from director device 14, and returns the result of the query to the one of endpoint devices 10.

In some examples, director device 14 permits certain users to place a legal hold on a particular file. When the legal hold is in place, director device 14 refuses to delete a file from local storage of director device 14 until certain criteria have been met. For example, the policy of director device 14 may specify a period of retention for the file or all files that are marked with the legal hold status. Therefore, the period of retention must have expired for the file before director device 14 will delete the file. Also, where a user who needs the file has not requested deletion of the file, director device 14 will not delete the file.

In certain circumstances, when a user requests deletion of a file that has a legal hold status, director device 14 will inform the user that the file has been deleted, without actually deleting the file. In this way, the legal hold status applied by director device 14 may supersede any actions taken by a user at one of endpoint devices 10, which may be important for entity compliance with policy, regulations, or laws on file retention. In some examples, a legal hold status persists indefinitely, until the legal hold status has been lifted by an authorized user, such as administrator 20 or administrator 16.

Accelerator devices 12 may generally act as a data cache for data of director device 14 and/or respective endpoint devices 10. Accelerator devices 12 may comprise one or more high-capacity computer-readable media for storing electronic data. Each of accelerator devices 12, for example, may include twelve one-terabyte drives, for a total storage capacity of twelve terabytes. When endpoint devices 10 connected to one or more of accelerator devices 12 store data to director device 14, endpoint devices 10 may in fact store the data to the accelerator device 12. Similarly, when endpoint devices 10 attempt to read data from director device 14, director device 14 may first send the data to accelerator device 12. In this manner, each accelerator device 12 may act as a cache for both endpoint devices 10 and director device 14.

In some examples, system 2 may be viewed as a hierarchical storage system, wherein each of endpoint devices 10 store a set of data (e.g., “active” files), accelerator devices 12 store all of the data of the corresponding endpoint devices 10 as well as additional data that endpoint devices 10 have not recently accessed (e.g., “inactive” files as well as “active” files), and director device 14 stores all of the data of accelerator devices 12 as well as additional data that accelerator devices 12 and endpoint devices 10 have not recently accessed (e.g., “active,” “inactive,” and “dormant” files). Therefore each higher-level of the hierarchy stores all of the data of the next lower-level of the hierarchy, as well as an additional data set not stored at the next lower-level of the hierarchy.

Although it is possible that all data of system 2 may be active at any one time, empirical studies have shown that, for most enterprises, between 60% and 90% of all enterprise data has not been accessed recently and will most likely not be accessed in the near future. In other examples, a policy may dictate that certain file types are to be stored directly to director device 14, without being stored to endpoint devices 10 and accelerator devices 12. In general, the storage scheme is controllable and configurable by administrators 16, 20 by configuring the policies of system 2.

When a user creates or obtains a new file using one of endpoint devices 10, the new file is given a “birth certificate” in the form of metadata that describes the new file. For example, the metadata file may include information such as an identification of the user who created the file, an identification of the one of endpoint devices 10 used to create the file, a date of creation, and a date of last access. The particular content of the metadata may depend on the policy configured on director device 14 by administrator 20. The endpoint device may also execute a hash function, such as Message-Digest 5 (MD5), on the file to create a unique identifier for the file and store the unique identifier in the metadata file. In general, files become “self aware” in that the metadata stores information regarding creation and access of the corresponding file.

Director device 14 stores only a single instance of each unique file. Therefore, when two or more users attempt to save identical documents, director device 14 stores a single instance of the document. For example, a first user may obtain and store a Portable Document Format (PDF) file, e.g., “example.pdf,” using a first one of endpoint devices 10. Later, a second user may also retrieve and store “example.pdf” from a different one of endpoint devices 10. Director device 14 may detect the fact that the first user already stored “example.pdf” by comparing a file signature produced by the second endpoint device having executed a hash function on the file when the second user attempts to store the file. Director device 14 may compare the file signature to file signatures of files already stored by director device 14, and in this way may determine that the file does not need to be saved a second time when the file signature matches the signature of a file stored by director device 14.

When the second user attempts to access “example.pdf,” accelerator 12 will present the first instance of “example.pdf” to the second user, which was stored when the first user stored “example.pdf.” In this manner, director device 14 may implement a “de-duplication” technique in which duplicative data is removed and stored as only a single instance in region 4. That is, a single instance of the data may be stored within director device 14 that is accessible to endpoint devices 10, assuming that the policy for the data permits access to the file. Endpoint devices 10 may store links to the file that appear to respective users as the file itself, although in actuality the file is stored at director device 14.

Each time an information object is accessed, director device 14 may update the metadata of the information object to reflect the most recent access to the information object and update database tables of director device 14 that identify the location of the file, if the location has changed. Director device 14 may also use other suitable means, rather than a database table, for identifying locations of the file. Director device 14 may comprise a plurality of physical hard drives and/or RAID arrays of hard drives, and therefore, the table may comprise indexes for identifying which of the hard drives or hard drive arrays currently stores the file. The table may use the file signature as a key that uniquely identifies the file.

Each of endpoint devices 10 may execute various functions on files before the files are stored to director device 14. Similarly, accelerator devices 12, director device 14, affiliate director device 8, and/or director archive 6 may automatically execute such functions on these files before or concurrently with storage of the files. For example, endpoint device 10 may execute an antivirus program on a file to be stored to director device 14 to prevent infected files from being stored in director device 14. Endpoint devices 10 may also encrypt a file to be stored to director device 14, where director device 14 may store the decryption key. That is, in some examples, endpoint devices 10 may each be configured with a public key of a public/private key pair, while director device 14 may store the associated private key. In this manner, only director device 14 may be capable of decrypting certain data stored in director device 14, in such examples.

Director device 14 may also execute a Content_Index function on stored information objects, which inspects text-based files for keywords. A user may then perform a search for particular keywords of a file to quickly locate a desired file when the user does not know the exact file name or file location. In one example, a user may also specify keywords for a file, whether or not the file is text-based, at the time the file is created and/or edited, so that users may quickly and easily find the file at a later time. Endpoint devices 10, accelerator devices 12, and/or director device 14 may also capture a preview representative of the file, e.g., an image of the first page of a text document, a frame of a video file, or a first page of a presentation file, and this captured data may be included in the metadata of the information object. The screenshot may then be presented to users browsing a directory that includes the file, who issue a query that matches the file, or otherwise attempts to access the file. In some examples, director device 14 may prevent viewing of the preview by users who do not have permission to access the file itself. In this case, director device 14 may instead display a preview indicative of the user not having permission to view the file, or may not display the file to the user lacking permission to view the file at all. Preview of files may be facilitated via the director/end point device via a preview algorithm. As a result set is hovered over with a pointer controlled by a mouse, requests for the file preview are able to either generate the preview locally or ask director device 14 specifically to send the preview. Director device 14 may then transmit the preview image back to the requesting endpoint device. Accelerator devices 12 can also facilitate in the task of providing preview images.

Users of endpoint devices 10 may also request to delete files. A first user of one of endpoint devices 10 may request to delete a particular file, for example. In response, the one of endpoint devices 10 may inform the first user that the file has been deleted, without actually deleting the file from director device 14. The endpoint device may instead simply delete the link to the file, without deleting the file from director device 14. Director device 14 may therefore preserve access by a second user to the file. In some examples, only authorized users, such as administrators 16, 20 may permanently delete files. For example, in response to the first user's delete request, director device 14 may send a message to administrator 16 informing administrator 16 of the delete request. Administrator 16 may then decide whether or not to permanently delete the file. In some examples, director device 14 may delete the file when the last user to have “saved” the file deletes the file, assuming that the policy for the file permits deletion. If the policy does not permit deletion, or if the file has been marked with a legal hold, director device 14 does not delete the file until the legal hold has been lifted and the policy permits deletion of the file. Thus, in general, director device 14 does not delete a file unless all users who have saved a link to the file have requested to delete the file, the policy for the file permits deletion, and the file is not marked with a legal hold. In some examples, even when some users still have links to a stored file, director device 14 may delete the file after the time for retention has expired and when the users have not recently (e.g., within a specified number of weeks, months, or years) accessed the file. Director device 14 may also force endpoint devices 10 to delete links to files. For example, director device 14 may cause endpoint devices 10 to search for and delete any links to a particular file. Director device 14 may search system 2 for files and links by name or binary signature to perform this “search and destroy” procedure.

In some examples, an administrator may force the deletion of a file, e.g., when a file is corrupted, infected with a virus, contains inappropriate information, or when an administrator otherwise determines that the file should be deleted. In such cases, the administrator may request to delete the file, and director device 14 may delete the file stored by director device 14, as well as causing affiliate director device 8 and director archive 6 to delete the file. Affiliate director device 8 and director archive 6 may also delete a file that is deleted normally, e.g., when all users request deletion, the policy allows for deletion, and no legal hold is in place for the file.

Administrators 16, 20 may configure deletion permissions using policies enforced by director device 14 as to whether or not to actually delete the file. That is, an administrator may set a status for files, e.g., whether the file is a personal file, an e-mail, a corporate file, or has some other status. For example, administrator 16 may configure director to automatically delete personal user files for a user, to send a message to the administrator for e-mail files, and to reject a delete attempt for corporate files when the deletion attempt occurs before a time period for holding the file, based on a policy, has expired. Deletion of files can happen automatically, manually, or after approval from authorized parties.

Administrators 16, 20 may establish or refine policies enforced by director device 14 to allow various permission levels among users of endpoint devices 10 for files stored within system 2. For example, administrator 16 may restrict access to files of administrator 16 to only administrator 16. Administrator 16 may also assign a first user to have full access to a set of files for a particular project, a second user to have only read access to the set of files, and a third user to not be able to see the set of files at all. Users may also have a hierarchical permission set for defining access policies or other permissions. For example, a standard user may be permitted to define an access policy for that user's files, a supervisor of the user may be permitted to override the access policy for the user's files and an access policy for a group to which the user belongs, and an executive may be permitted to override the supervisor's access policies and set a policy for the enterprise.

In some instances, administrators 16, 20 may set certain files to automatically delete after a certain period of time. For example, administrator 20 may configure a policy of director device 14 to automatically delete files classified as “business records” after a legally required period for retention, e.g., seven years. Each user who has access to the files may request deletion thereof, and accelerator 12 may indicate to the users that the files have been deleted, without actually deleting the files. When recovery of the files is required (e.g., after all users have requested deletion of the files), administrator 16 may recover the files by providing a link to the files to one or more users of endpoint devices 10. After the required period for retention has elapsed, director device 14 may actually delete the files (assuming that all users have requested deletion thereof and all administrators have approved the deletion, if required). In some examples, administrators 16, 20 may force deletion of files even when users thereof have recently accessed the files. In one example, when each user of a particular file has requested deletion thereof, but the file is to be retained for a retention period, director device 14 may preserve the file until the time period for retention established by the file's policy has been exceeded.

In one example, director device 14 may also implement tasks performed by an e-mail server, rather than including e-mail server 22. That is, director device 14 may implement e-mail server procedures and techniques. In other examples, a separate e-mail server, such as e-mail server 22, may perform e-mail sending and receiving procedures by implementing e-mail protocols, such as the Internet Message Access Protocol (IMAP), the Post Office Protocol (POP), the Simple Mail Transfer Protocol (SMTP), or other e-mail protocols, while storing e-mail data on director device 14. When a user of one of endpoint devices 10 receives an e-mail, the e-mail may be stored within director device 14. Similarly, when a user sends an e-mail, a copy of the sent e-mail may be stored within director device 14. Moreover, e-mails may also be converted to information objects as described in this disclosure before being stored within director device 14. In this manner, director device 14 may generally treat e-mails in a manner similar to and consistent with other files stored within director device 14.

Director device 14 may present a virtual file system throughout system 2 to, e.g., users of endpoint devices 10. When a user of one of endpoint devices 10 opens a file directory, a user interface of the one of endpoint devices 10 may request a list of files present in the directory from director device 14 and may receive the list of files from director device 14. In one example, director device 14 captures a thumbnail snapshot of each file stored within system 2 and sends the thumbnail snapshots to the one of endpoint devices 10 that is opening the directory. The one of endpoint devices 10 may then present the thumbnail snapshots of each of the files stored in the directory to the user. In this manner, the user may more easily determine whether a particular file to be opened is in fact the file that the user desires to open. The user may then decide whether or not to open the file, after viewing the thumbnail snapshot. Director device 14 may store the thumbnail within the metadata of an information object that includes the file, as described in greater detail below. Optionally, the endpoint device can request a version of the full file to download instantly (e.g., in response to a user hovering a pointer controlled by a mouse over the file) that allows the endpoint device itself to render the preview.

Because director device 14 generally stores all information objects for region 4 of system 2, a particular user may log into any one of endpoint devices 10, and the one of endpoint devices 10 may present the user with all of the user's files. For example, the user may typically work on one of endpoint devices 10. The user may, however, log into a different one of endpoint devices 10, which the user has never before logged into. Nevertheless, the one of endpoint devices 10 may present the user with all of the user's files as if the user had logged onto the endpoint device on which the user typically worked. To do so, when a user logs into one of endpoint devices 10, the endpoint device queries director device 14 for the user's files. This process generally occurs without the user's knowledge. Therefore, a user of system 2 may log into any one of endpoint devices 10, and the one of endpoint devices 10 may present the user's files to the user, regardless of which of endpoint devices 10 the user has logged into.

A user of one of endpoint devices 10 may also edit an existing file of system 2. When the user edits the file, director device 14 stores the original version of the existing file, as well as a version of the file including the edits made by the user. In one example, when the user selects the edited file, e.g., by clicking a right mouse button on the file, the one of endpoint devices 10 being used by the user may display a menu to the user that depicts two or more versions of the file that are available to be opened, as well as an indication of the relative version, e.g., a date on which the revision was saved, a revision number, or another indication. Therefore, the user may select the most recent version, or an earlier version of the file. The endpoint device may query director device 14 directly (and affiliate director device 8, e.g., when affiliation is configured) which, via search return results, may dynamically redirect the file open from director device 14, director archive 6 if the file is not in the local director pool, the nearest one of accelerator devices 12, the endpoint device's own local storage, or from a nearby endpoint device.

When the user selects the most recent version, director device 14 informs the one of endpoint devices 10 of the location of the most recent version, whereas when the user selects an older version, director device 14 informs the one of endpoint devices 10 of the location of the selected older version of the file. The one of endpoint devices 10 then may open the selected version of the file by retrieving the selected version from the location received from director device 14. In some examples, the policy of director device 14 may establish a maximum and/or minimum number of available revisions of the file that are depicted in the menu and available for retrieval. Because files are saved as information objects, moreover, even if a user changes the name of a file upon editing the file, director device 14 may still be capable of retrieving the older versions of the file. To accomplish this, director device 14 may associate the newly-named information object with the older version of the information object in metadata of the information object.

System 2 may present a number of advantages over other storage systems, e.g., systems for storing data of an enterprise or other entity. For example, system 2 may be capable of storing more unique data per unit of available storage, because system 2 may be capable of de-duplicating data. That is, system 2 may be capable of storing a file exactly once at any given level of a hierarchy of storage. System 2 may also index stored files, e.g., by keywords, therefore system 2 may allow efficient access to files based on keyword searches, rather than requiring a user to identify a file by name and/or directory location. System 2 may also ensure that only the most relevant data is stored proximate to a user and that less relevant data is removed from local storage, e.g., a computer-readable medium of endpoint devices 10.

In general, affiliate director device 8 behaves in a manner similar to director device 14, but for a different region than region 4. However, affiliate director device 8 may remain coupled to director device 14 to provide redundant data storage for particularly important files. Remote administrator 18 may perform administration of affiliate director device 8 and other computing devices of a region that includes affiliate director device 8. When a user of region 4 logs into an endpoint device of the region associated with affiliate director device 8, affiliate director device 8 may retrieve the user's files from director device 14 to enable the user to view that user's files. In this manner, system 2 may provide a mechanism by which users may move between regions without losing access to their data. In some examples, a policy for a particular user may dictate that the user's files always be saved to both director device 14 and affiliate director device 8, e.g., for a user who is constantly moving between regions. Although only one affiliate director is shown in the example of FIG. 1, other examples may include a plurality of regions and associated affiliate directors.

Files can be optionally classified by user or administrator definable classification groups that allow a macro definition of a file's purpose. This definition of the file's purpose may overcome the micro level of MIME-type only handlers. After a file is enrolled or processed in director device 14, definable conditions may provide extended metadata about the file that adds it to a classification when applicable.

Because director devices, such as director device 14, affiliate director device 8, and director archive 6, store and manage file storage for system 2, system 2 may in essence provide unlimited storage. For example, users of endpoint devices 10 need not be concerned with an amount of storage available on the director devices, because an administrator, such as administrators 16, 20 and remote administrator 18, may upgrade corresponding director devices with additional storage capabilities, e.g., by adding additional hard drives to the director devices. The director devices may then automatically, transparently to the users of endpoint devices 10, use the additional storage space. Likewise, director device 14 and/or affiliate director device 8 may ensure that data is stored to director archive 6 and remove copies of the data from local storage of director device 14 and/or affiliate director device 8, such that additional storage space is made available for these devices (e.g., deduplicating storage of files). Accordingly, system 2 may essentially provide an unlimited amount of storage to users of endpoint devices 10, without the users' necessary knowledge or awareness of how the unlimited storage is accomplished. The operational synergism between the information director and the archive director may create a file system of virtually unlimited capacity where, as long as information objects are archived, yet remain active and accessible, then information need not reside anywhere else in the system.

Search queries can be propagated across director devices, e.g., across director device 14 and affiliate director device 8, whereby all affiliated directors may be included, each returning it's own results for what is stored by the respective device. All result subsets may then be assembled and returned to the requesting endpoint device. In the event that a file is requested that is resident on a different director device than the one servicing a requesting endpoint device, a closest file first algorithm may be invoked to obtain the file from either the common archive director (e.g., director archive 6), 2) the director that has that specific file, 3) a nearby accelerator that is known to have the file, or 4) from a endpoint device that is known to have the file. Further, files shared between affiliated director devices can place restrictions on accessed files by centralized policy limiting file residency length, copy protection, saving to removable media, or other similar techniques.

In general, a director device 14 may have a certain amount of “pool” storage. That pool can be any size, and multiple fixed pools can be attached to a director. When the used pool space gets to a policy-configured full percentage, the files that are confirmed on a director archive may be automatically dropped out of that pool by oldest date or according to a least accessed date algorithm, e.g., in accordance with a least-recently-used algorithm. If one considers that almost 80% of what users create is not accessed again, this means that system 2 may be able to service the storage needs with an exponentially smaller sized physical disk array at director device 14. In effect, these techniques may allow for unlimited storage, also referred to in this disclosure as a “bottomless disk.” This principle is also applicable to endpoint devices 10. When the user creates information objects, they can be hard-linked and therefore relatively non-space consuming, thereby creating a bottomless disk on the endpoint device as well.

In some examples, director device 14 may, e.g., at the request of an administrator, selectively audit one or more of endpoint devices 10. When one of endpoint devices 10 is subject to an audit, director device 14 may capture all files and metadata created, opened, edited, stored, or otherwise handled by a user of the endpoint device. In this manner, director device 14 may create a full audit trail and chain of evidence report for files with which the endpoint device has interacted.

Using the audited information received by director device 14, director device 14 may provide file history and/or a chain of evidence in graphical and/or textual format as a report to show the complete life of a file, from inception to its current state, and all those who have interacted with the file. For example, an auditor may signal a specific endpoint, a group of endpoints or all endpoints to enable and start audit tracking. Upon notification, the user endpoint device relays via messaging over a network interface card any and all file actions initiated by a user of the endpoint device to director device 14.

Users may optionally enroll older medium- to long-term archive media into director device 14 to allow elimination of old formats. For example, a customer may have a large amount of off-site tape drives from existing or old tape backup devices. These tapes can be read into temporary storage and then enrolled into director device 14, and thereby processed for deduplication and/or retention expiration management.

In some examples, director device 14 may store files destined to be stored at director archive 6 onto a temporarily mounted storage device, such as a USB disk or Firewire disk. Director device 14 may be configured via policy to redirect all file objects to this media. Director device 14 may compress and/or encrypt the files as normal, but instead of going over the wide area network connection, which may be at capacity, files may be stored on the removable device. Upon request or via a policy condition point, a use may detach the removable device from director device 14 and shipped physically to director archive 6. During this time, director device 14 may queue all new file changes destined for director archive 6 until signaled to continue after the removable media files are stored by director archive 6 or by an administrator. After attaching the removable media device to director archive 6, director archive 6 may store and process all of the files from the removable media as if they were transferred remotely, and a full manifest is also created. This manifest is then returned to the director device and processed to update the proper metadata elements as to the disposition of the file storage.

An endpoint device can keep a dynamic record of all files currently processed by way of a hidden file manifest. Each hidden file contains the unique hashes of all files at its level. If no file exists, then this is an indicator that a scan needs to be performed. Scans can be done automatically (such as when the endpoint agent senses a large amount of change has happened), manually by the endpoint user by means of a user interface button, or via policy from the director device to that specific endpoint device, group of devices or all devices. This proprietary means allows users to disconnect their endpoints and work remotely, yet all changes are automatically sensed upon reconnection to the director device network. Further, it allows a minimal footprint in size, memory and CPU use as no database or other special facilities are needed.

Director archive 6 (which may also be referred to in this disclosure as a “vault” or “vault device”) may use a RAID-like system that allows use of common components, yet stores archived objects in at least two distinct locations. For example, when a file is received by the vault director, it is compared against other objects for binary uniqueness. If the file is not unique, reference pointers are created to the existing object and the file is deleted. If the file is new, reference pointers are created, the file is then targeted against the next available storage node medium. Storage nodes are added in pairs to the vault director controller hardware. In some examples, each storage node has at least 12 disks, each mounted individually to the storage node but on a hot pluggable interface. After a successful write, pointers are updated and the file is written to the storage node's sister device and drive. Upon successful write, the pointers are updated and the calling system is notified of a successful store, to insure file accuracy and quality. Storage nodes can be added in pairs. Director device 6 can also be directed via policy to replicate this stored file to another configured vault for dual redundancy. By utilizing this storage system and unique file object storage signatures, true enterprise deduplication can be attained.

FIG. 2 is a block diagram illustrating elements of an example information object 30. In the example of FIG. 2, information object 30 includes metadata 32, policy data 46, and file data 48. As described above, system 2 may utilize information objects, such as information object 30, which may be created from traditional files such as, for example, text documents, spreadsheet documents, PDF documents, e-mail messages, presentation documents, music data, video data, image data, or any other types of files/data. Information objects may also be created from file directories. That is, a computing device may be configured to automatically append metadata to a directory to describe ownership of the directory and/or policies regarding the directory. Moreover, policies may be created and enforced relative to information objects for directories as well.

Metadata 32 may generally describe information object 30, while policy data 48 may describe policies with respect to information object 30, such as how endpoint devices 10 may interact with information object 30, an archive time for information object 30 during which director device 14 and/or director archive 6 may not delete information object 30, whether a legal hold applies to information object 30 that prevents information object 30 from being deleted even after the time of retention has passed for information object 30, users or devices who may access and/or manipulate information object 30, whether information object 30 is to be compressed and/or encrypted, as well as compression and encryption schemes to use to compress/encrypt the information object, or other data regarding policies as described in this disclosure.

In the example of FIG. 2, metadata 32 includes file type value 34, preview value 36, creation date value 38, last access value 40, file name value 42, and author value 44. In other examples, additional metadata may also be included. For example, administrator 20 or administrator 16 may configure file-type-specific metadata values, that is, metadata that is only present for particular file types or Multipurpose Internet Mail Extension (MIME) types. For example, when information object 30 comprises an electronic mail document (e-mail), metadata 32 may include a plurality of pairs of (participant, role) values, where the participant value identifies a person, e.g., by e-mail address, and the corresponding role value identifies the participant's role in the e-mail, e.g., whether the person was a sender, receiver, carbon-copied receiver, or blind-carbon-copied receiver.

As another example, metadata 32 may comprise statistics regarding information object 30 based on the type for information object 30. For example, for word processing documents, metadata 32 may comprise a number of revisions, a word count, a character count, a page count, identifiers of editors (that is, who has opened, modified, and saved the document), or other such metadata. As another example, for a picture document, metadata 32 may comprise an image size value, an image resolution value, an image source value (for example, whether the image was retrieved from a digital camera, downloaded from the Internet, an Internet address from which the image was retrieved), or other such metadata.

With respect to the example of FIG. 2, file type value 34 identifies a file type for information object 30. In general, an endpoint device may set the value of file type value 34 based on an extension to the file name for information object 30. In some cases, however, the file type for an object may not match the extension for the object, e.g., where a user has intentionally or inadvertently changed the extension to the file name. In such cases, the endpoint device may modify file type value 34 based on an application used to open information object 30, as well as whether the application was able to successfully open information object 30. For example, if the extension identified a file as being a text document, but a movie player successfully opened and played information object 30, the endpoint device may modify the value of file type 34 to reflect information object 30 being a video object. The endpoint device may also set file type value 34 according to a received MIME type for the file.

File name value 42 may comprise a name for the file of information object 30. In some examples, the end of file name value 42 includes an extension (e.g., “.txt,” “.doc,” “.jpg,” “.wmv,” or the like) that indicates a file type for information object 30, from which an endpoint device or director device 14 may determine the file type for file type value 34. File data 48 of information object 30 may generally include the original file from which information object 30 was created. For example, when a user stores a PDF document entitled “example.pdf,” file data 48 may comprise data for “example.pdf,” while file name value 42 may be set to “example.pdf.” Similarly, file type value 34 may be set to PDF or, more generally, a value indicative of a text-based document.

Preview 36 comprises a snapshot of data within file data 48 of information object 30. For example, when information object 30 comprises a word processing, spreadsheet, or presentation document, preview 36 may comprise an image of the first page of the document. As another example, when information object 30 comprises video data, preview 36 may comprise a frame of the video data. The frame may be stored within preview 36 at a reduced resolution size.

Creation date 38 may comprise a date and time value for when the original version of information object 30 was created. Author value 44 may comprise an identifier for the user who created information object 30 on the date specified in creation date value 38. Director device 14 may also update last access value 40 as information object 30 is accessed by various users. Last access value 40 may initially be set to the value of creation date 38. As users open information object 30, director device 14 may update the value of last access value 40 to record an identifier for the user who opened information object 30, the date when information object 30, and whether any changes were made by the user.

Information object 30 also includes policy data 46 in the example of FIG. 2. Policy data 46 may generally correspond to data for policies relevant to information object 30. For example, policy data 46 may include permissions for various users. In one example, a user listed in author value 44 may, by default, be given read and write permissions for information object 30, although various policies may modify this default behavior. Policy data 46 may include a date value when information object 30 may be deleted. In one example, the deletion date may comprise a value that is seven years greater than the value of creation date 38. Policy data 46 may also include a legal hold flag that may be toggled by an administrator or other user with privileges to institute a legal hold, which may prevent information object 30 from being deleted. Policy data 46 may also comprise other data relevant to particular policies for information object 30.

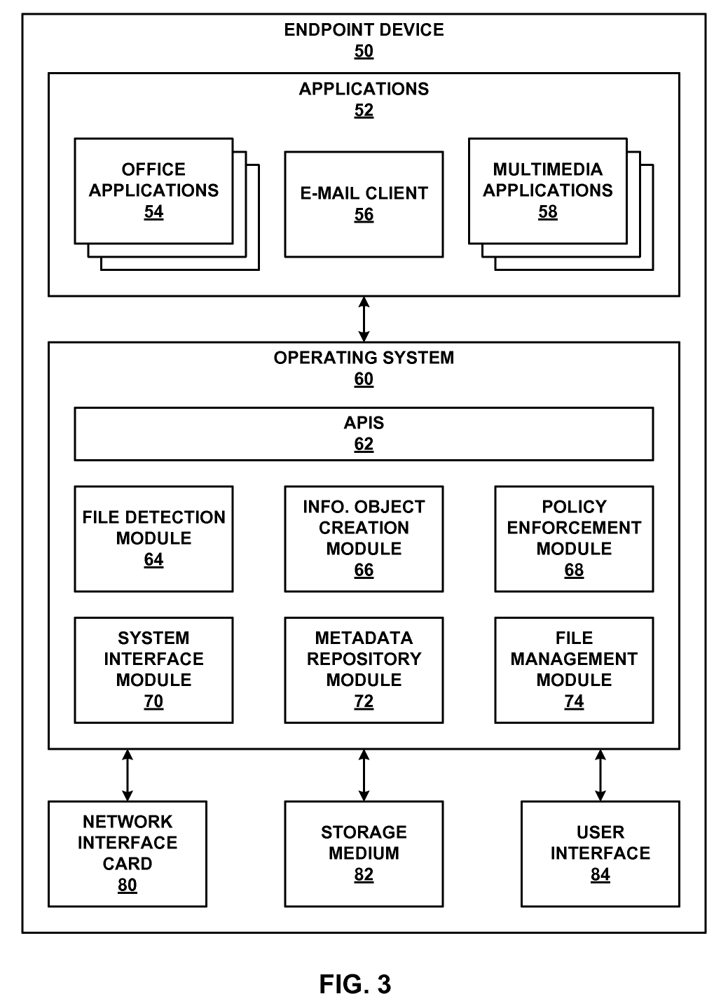

FIG. 3 is a block diagram illustrating components of an example endpoint device 50. Endpoint device 50 may correspond to any of endpoint devices 10. In the example of FIG. 3, endpoint device 50 includes applications 52 executing within operating system 60, as well as network interface card 80, storage medium 82, and user interface 84. In general, the techniques of this disclosure, with respect to endpoint devices, may be performed at the operating system level. For example, an operating system module or driver may be configured to perform the functions attributed to endpoint devices 10, 50 with respect to the techniques of this disclosure. Therefore, existing applications, such as applications 52, may continue to operate as normal, without needing to be modified to incorporate the techniques of this disclosure.

In the example of FIG. 3, applications 52 include office applications 54, such as, for example, word processing applications, spreadsheet drafting applications, presentation preparation applications, and drafting applications, or any other standard office applications that save, load, and modify files. Applications 52 also include e-mail client 56, which is configured to send and receive e-mail. As discussed above, e-mail is treated in a manner similar to other files in accordance with the techniques of this disclosure. Applications 52 also include multimedia applications 58, such as image viewing applications, image editing applications, video playing applications, video editing applications, music playing applications, or other multimedia applications.

Operating system 60 provides application programming interfaces (APIs) 62 to applications 52 for interaction with low-level operating system features, such as saving and loading of files. Operating system 60 includes file detection module 64, information object creation module 66, policy enforcement module 68, system interface module 70, metadata repository module 72, and file management module 74. Although illustrated as distinct modules, file detection module 64, information object creation module 66, policy enforcement module 68, system interface module 70, metadata repository module 72, and file management module 74 may be functionally integrated. Additionally or alternatively, any of the modules or functions attributed thereto may be implemented in a respective hardware unit, such as a digital signal processor (DSP), application specific integrated circuit (ASIC), field programmable gate array (FPGA), or any other equivalent integrated or discrete logic circuitry, as well as any combinations of such components. Instructions for operating system 60 and modules thereof may be stored on a computer-readable storage medium, such as storage medium 82, and executed by one or more processors (not shown). Endpoint device 50 also includes network interface card 80, storage medium 82, and user interface 84. APIs 62 may provide access for applications 52 to communication over a network via network interface card 80 and to user interface 84, e.g., a display, a keyboard, a mouse, a touchpad, a touch screen, speakers, or other user interfaces that provide output to or receive input from a user.

In general, a user may interact with endpoint device 50 without any knowledge of the data storage scheme implemented by operating system 60 in accordance with the techniques of this disclosure. Similarly, as stated above, applications 52 need not be redesigned or reprogrammed to be compatible with the techniques of this disclosure. Accordingly, when a user uses one of applications 52 to create and save a document, the user need not have any awareness of other elements of system 2, e.g., director device 14. Instead, file detection module 64 generally detects events that are associated with file creation events, e.g., when a user saves or closes a document. In general, when a user of endpoint device 50 saves a document, file detection module 64 detects the save event and, rather than saving the document to storage medium 82 that is local to endpoint device 50, determines whether the document is a new document with respect to region 4 (FIG. 1). In some examples, the document may be temporarily saved to storage medium 82, to cause storage medium 82 to act as a cache for the document. However, when the document is actually saved and closed, the document may be deleted from storage medium 82. In some examples, e.g., based on policy configuration, documents saved at a particular endpoint device may be stored in the local storage medium of the endpoint device. In cases where workstations are remote or disconnected (e.g., laptops and handheld devices) local file residency may enhance the user's experience while not in communication with director device 14 or where the communication is subject to relatively high latency.

To determine whether a saved document is a new document, file detection module 64 may execute one or more hash algorithms on the document after the document is saved to produce a file signature for the document. File detection module 64 may then send the file signature to director device 14 via network interface card 80 along with a request to determine whether the document is a new file. Director device 14 may compare the file signature to saved file signatures and, if the file signature does not match any of the saved file signatures, may issue a response that indicates that the document is a new file. On the other hand, when the file signature matches one of the saved file signatures, director device 14 may respond that the document is not new. In some examples, metadata for the file is also sent to director device 14, to ensure that the file is properly logged and that the user's exposure to the file is properly registered, in the event that the file already exists.

Assuming that the saved document is new, information object creation module 66 creates an information object similar to information object 30 (FIG. 2) for the newly saved document. Metadata repository module 72 stores metadata for a user of endpoint device 50, e.g., in storage medium 82, such as an identifier of the user. Information object creation module 66 may query metadata repository module 72 to retrieve stored metadata to be used to set values of metadata for the information object to be created. Information object creation module 66 may determine a file type for the new file by examining an extension to the file name or by determining a program that was used to save the file. Information object creation module 66 may also retrieve a current date and time from operating system 60 to establish the metadata for the information object.

Information object creation module 66 may also set policy data for the information object based on a number of elements, including the user who created the document, an identification of endpoint device 50 used to create the document, a file type for the document, a save location for the document, or other factors. Information object creation module 66 may determine one or more policies for the information object based on these elements of the file to determine how to set the policy data for the newly created information object. Information object creation module 66 may then send the information object to director object 14 for storage.

When a user attempts to access or save a file, policy enforcement module 68 determines whether the user is permitted to perform the requested access or save operation. For example, certain policies may permit a user to store a file to director device 14, but not to an external storage medium, such as a thumb drive, writeable or re-writeable CD, writeable or re-writeable DVD, or to send the file as an attachment to an e-mail. Therefore, when the user attempts to write a file to a storage medium in violation of the policy, policy enforcement module 68 detects and prevents the write request.

System interface module 70 is generally configured to interact with devices of system 2, e.g., accelerator device 12 and director device 14. System interface module 70 may send information objects to and receive information objects from director device 14 via network interface card 80. System interface module 70 may also create links to stored information objects. In general, when a user saves a file, the file is automatically converted to an information object and stored to director device 14, while a link to the file is stored to endpoint device 50. However, the link may generally appear to the user as if the link were the file itself For example, endpoint device 50 may present an icon to a user that is representative of the file, as opposed to a shortcut icon, in a particular directory or on the user's desktop, even thought the actual data for the file is stored in director device 14. The link may be stored in a directory structure created and maintained by the user of endpoint device 50, such that from the user's perspective, the file appears to be stored on the user's local endpoint device.

File management module 74 may be configured to manage links stored locally to endpoint device 50 and linked-to information objects stored at director device 14. File management module 74 may also retrieve metadata from accessible files stored at director device 14, such as, for example, previews, file names, and file types. In some examples, file management module 74 also provides access to files for which links are not stored within endpoint device 50. For example, file management module 74 may provide a user with the ability to search director device 14 for files matching particular search criteria. The search criteria may include one or more of keyword describing the file contents, the file type, the file name, an author, a creation date, a last-modified or last-accessed date, policies for the file, whether the file can be deleted, whether the file is subject to a legal hold, or other such search criteria.

In this manner, system 2 may reduce redundant data storage across an enterprise, such that data backups may be performed automatically, e.g., by simply updating director archive 6 with new or modified files, and without writing redundant data to backup tape drives. Moreover, documents that are common to a plurality of users may be stored once, but be readable by all of the plurality of users. Furthermore, by not storing corporate documents in storage medium 82, endpoint device 50 may reduce the possibility of unintentional security violations. For example, if endpoint device 50 is lost or stolen and recovered by a third party without access privileges, the third party may not be able to access corporate data via endpoint device 50, because the corporate data may be stored at director device 14 and not on storage medium 82. Moreover, the third party may not have knowledge of an account that can be used to access director device 14. Furthermore, when a user of endpoint device 50 realizes that endpoint device 50 is missing, policies may be updated to prevent access to director device 14 by endpoint device 50, e.g., by preventing access to director device 14 by filtering devices having a media access control (MAC) address that matches the MAC address of network interface card 80.

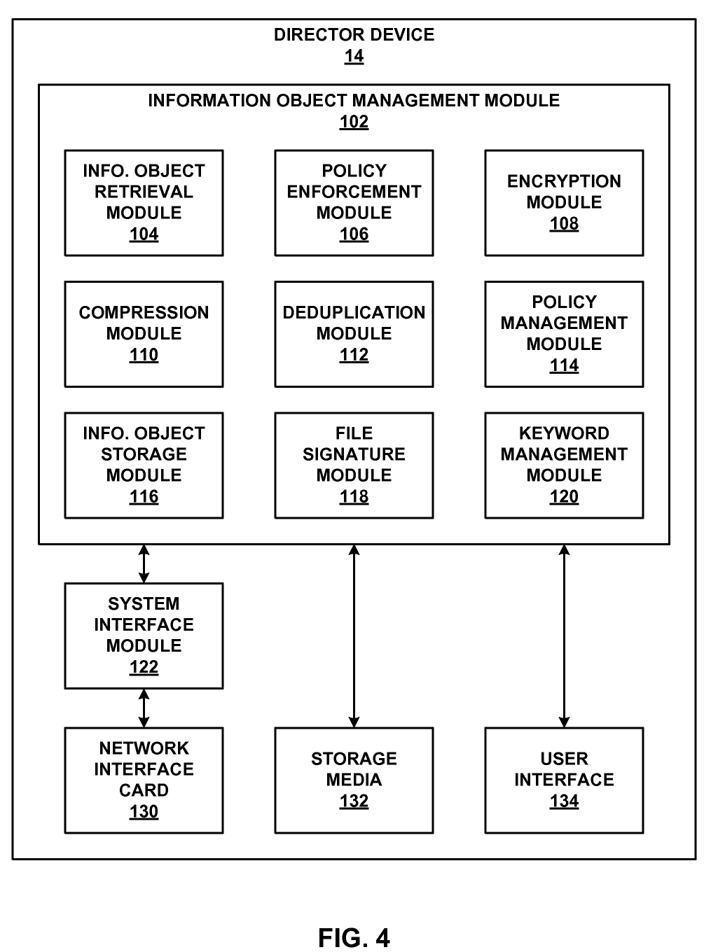

FIG. 4 is a block diagram illustrating an example arrangement of components of director device 14. Affiliate director device 8 may include similar features and components to those depicted in FIG. 4. In the example of FIG. 4, director device 14 includes information object management module 102, system interface module 122, network interface card 130, storage media 132, and user interface 134. Information object management module 102 and modules thereof, as well as system interface module 122, may be functionally integrated, but are depicted as separate units and modules for the purpose of example. Instructions for information object management module 102 and modules thereof, and for system interface module 122, may be stored in a computer-readable storage medium, such as storage media 132, and executed by one or more processors (not shown).

Information object management module 102 includes modules for managing stored information objects, as well as modules for controlling storage of new information objects. In the example of FIG. 4, information object management module 102 includes information object retrieval module 104, policy enforcement module 106, encryption module 108, compression module 110, deduplication module 112, policy management module 114, information object storage module 116, file signature module 118, and keyword management module 120.

When an endpoint device, such as one of endpoint devices 10, attempts to access an information object, policy enforcement module 106 first verifies that a user of the endpoint device has sufficient permissions to access the information object. Policy enforcement module 106 may check policies of the information object to determine whether the user has the correct privileges to access the information object. For example, policy enforcement module 106 may check whether the user is explicitly permitted to access the information object, is explicitly prohibited from accessing the information object, or whether the user is a member of a class of users or a group that is either explicitly permitted or restricted from accessing the information object. Assuming that the user is permitted to access the information object, information object retrieval module 104 sends data for the information object to the endpoint device from which the request for the information object originated. In particular, information object retrieval module 104 determines a location of the information object within storage media 132, extracts the information object data, and sends the data to the endpoint device via network interface card 130.

When a user stores a new information object to director device 14, information object storage module 116 may store the new information object to a physical location within storage media 132. In this example, it is assumed that the endpoint devices in communication with director device 14 are configured to first determine whether the information object is new, in which case director device 14 may first receive a request from the endpoint device regarding whether a file signature for the information object matches existing file signatures recognized by director device 14. File signature module 118 may generate file signatures for existing information objects stored within storage media 132, and in some examples, file signature module 118 may store file signatures in a dedicated region of storage media 132. Accordingly, when director device 14 receives a file signature from an endpoint device along with a request to determine whether the file signature is new, file signature module 118 may compare the file signature to the existing file signatures and, when the received file signature does not match any of the existing file signatures, send a signal to the endpoint device indicating that the information object corresponding to the file signature is new.

The endpoint device may then send the information object to director device 14. Information object storage module 116 may store the information object in a location of storage media 132. In some examples, policy enforcement module 106 may first verify that the user has sufficient permissions to store a new file to director device 14. Policy enforcement module 106 may also determine whether policies for the information object have been complied with, e.g., whether policy data for the information object have been set correctly. When a policy for the file type of the information object requires encryption, encryption module 108 may encrypt the information object in accordance with an encryption scheme associated with the policy. Similarly, when a policy for the file type of the information object requires compression, compression module 110 may compress the information object in accordance with a compression scheme associated with the policy. An endpoint device can dynamically bundle groups of file objects and associated file object metadata items by a dynamic bundle or batch size. For example, a user may add a new endpoint device under their ownership that has a large number of files to be processed. Rather than processing one file at a time, the new endpoint device may send bundles of files to director device 14, depending on the current load of director device 14, thereby reducing round trip I/O waste.

In some examples, deduplication module 112 may further verify, when the information object is stored or periodically, that the information object is not the same as other information objects stored within storage media 132. In general, director device 14 attempts to remove redundant storage of data, except to the extent that storage media 132 may be configured in a RAID array. That is, where two hard drives, for example, of storage media 132 are not configured in a RAID array, and where the two hard drives store the same file, deduplication module 112 may remove a copy of the file from one of the two hard drives.

Deduplication module 112 may also remove duplicated files stored throughout system 2 and/or cooperate with deduplication modules of other director devices, such as affiliate director device 8 or director archive 6, to remove duplicate files from system 2, e.g., to ensure that links stored by various endpoint devices 10 to a particular file are directed to the same instance of the file. In some examples, director archive 6 may initiate a deduplication procedure to remove files stored by director device 14 and other directors, such as affiliate director device 8, to ensure that the only copies of the files are stored by director archive 6.

When a new information object is stored, keyword management module 120 may further associate keywords with the information object, e.g., so that other users can search director device 14 for a file using the keywords. For text-based documents, keyword management module 120 may scan the text of the document to determine certain words that should be captured. Keyword search may capture words that are unique such as nouns, pronouns, adjectives, adverbs, and may ignore certain short, common words, such as “the,” “an,” “and,” “a,” “to,” and other words that are generally common to all text documents. Keywords may also be reduced to their simplest form. For example, the word “Shipping” in a document, may be reduced to the form “ship.” For non-text documents, such as images, video data, and other multimedia data, keyword management module 120 may receive keywords from a user who stored the information object and associate those keywords with the information object. One feature of this keyword management is the ability to “trap” keywords that have been identified by a user at time of creation, and from that “trap”, determine a workflow, such as to route the document to a folder for compliance review.

When a user opens, modifies, and subsequently saves an existing information object, information object storage module 116 may store the revised file as being related to the original, but as belonging to the user who modified the document. Accordingly, the user may elect to view either the revised or the original version of the file when the user subsequently selects the link to open the file. Other users may continue to view the original document when the other users select the link to the document. Similarly, in some examples, a plurality of users may be members of a group, such that any one of the members who modifies a particular document will cause the document to be saved as a revision for the group. In this manner, each member of the group may continue to revise the document as a part of the group. Director device 14 may store an identifier of the group as the author, e.g., within author value 44 of the metadata for the information object, rather than an identifier of one of the users of the group. Revisions may be determined by any or all of file name, owner, date, group identifier, directory identifier, and machine identifier. This way, files that are shared via a group definition can maintain revisions by filename, owner and date, while individual files on the user's endpoint device or private storage location can use the filename, owner, date and optionally directory and machine identifier.

In general, any file that has a file handler configured, can be indexed for content, including optical character recognition (OCR) scans of images. Further, many files have relevant header data that can be extracted and indexed such as AutoCad files, JPG files and other “non-text” files. This text is available via file handlers which can extract any relevant text upon enrollment. Any and all text can be indexed and optimized in word “lexemes.” These lexemes are common word formats which also include the word position within the document for word association searches. Further, content indexing can support common word elimination and multi-byte languages. Languages can also support customizable dictionaries for industry-specific uses. The system is also not limited to one language at a time, as any number of languages can be added provided word definition files are included.

Keyword management module 120 may further implement search procedures to locate information objects that match certain keywords received from a user. For example, keyword management module 120 may allow a user to search by any or all of file type, file name, portions of a file name, keywords associated with an information object, author, creation date, last access date, or other search criteria. In some examples, keyword management module 120 may prevent files from appearing in search results when the searching user does not have sufficient privileges to access the files, e.g., as determined by policy enforcement module 106. For example, a user in Human Resources may be able to see Social Security Numbers, while users in other areas may not have access rights to see that keyword. Keyword management may be controlled by three variables, the keyword itself, the condition, and the category. A fourth variable, Action, may define the workflow to trigger on the Condition.

User interface 134 may comprise any user interface for providing output to or receiving input from a user. For example, user interface 134 may include any or all of a display, a keyboard, a mouse, a touchpad, a touch screen, speakers, or other user interfaces. An administrator may interact with director device 14 to perform various administrative tasks. As an example, the administrator may modify policies via user interface 134. Policy management module 114 may enable an administrator to add, update, or remove policies. The administrator may configure policies based on any or all of a user identifier, a user role, a file type, a file creation date, a file location, a desired storage location, or other elements associated with a file. When policies are updated, policy management module 114 may push the new and/or updated policies to endpoint devices coupled to director device 14. Moreover, endpoint devices may be configured to automatically check for and retrieve policy updates upon connecting to director device 14. The administrator may further subject individual information objects, or information objects matching certain criteria, to a legal hold, which prevents deletion of the information objects subject to the legal hold until the legal hold is lifted. Although user interface 134 may be provided for administrators to configure policies directly through director device 14, administrators may also interact with director device 14 via an endpoint device in communication with director device 14. Director device 14 may interact with endpoint devices and accelerator devices via network interface card and system interface module 122.

In some examples, encryption module 108 may be configured to utilize time-dependent keys. That is, encryption module 108 may periodically change a key used to encrypt, and likewise, modify the key necessary to decrypt, data based on a time at which the data is stored to and encrypted by encryption module 108. Encryption module 108 may store a time at which the data was encrypted/stored as plan text metadata along with the file, such that the appropriate key can be determined for decrypting the data. The key may comprise either a symmetric or an asymmetric key. In this manner, assuming an unauthorized third party were to gain access to storage media 132, and the third party were to acquire one of the keys, the third party would only be able to decrypt a small portion of storage media 132. Encryption module 108 may be configured to cycle through a set of keys periodically or to generate new keys periodically. The periodicity with which encryption module 108 may utilize different keys may be configurable by an administrator, e.g., every N hours, days, weeks, months, or years.

Storage media 132 may comprise any combination of storage media for a computing device. For example, storage media 132 may include any or all of a hard disk, a solid state drive (SSD), flash memory, a thumb drive, a tape drive, a CD-ROM, a DVD-ROM, or a Blu-Ray disc. Storage media 132 may be configured in one or more RAID arrays to provide fault-tolerant storage of data. Data from storage media 132 may also be backed up to a director archive, such as director archive 6 (FIG. 1).

Information object storage module 116 and information object retrieval module 104, in some examples, may together implement the Lightweight Directory Access Protocol (LDAP). In general, LDAP is a protocol for interacting with directory services over a network communication protocol, such as TCP/IP (Transmission Control Protocol/Internet Protocol). Accordingly, storage media 132 may organize stored information objects in a hierarchical fashion. LDAP is described in greater detail in the following documents: RFC 4510, “LDAP: Technical Specification Road Map,” Network Working Group, edited by K. Zeilenga, OpenLDAP Foundation, June 2006; RFC 4511, “LDAP: The Protocol” Network Working Group, J. Sermersheim, Novell, Inc., June 2006; RFC 4512, “LDAP: Directory Information Models,” Network Working Group, K. Zeilenga, OpenLDAP Foundation, June 2006; RFC 4513, “LDAP: Authentication Methods and Security Mechanisms,” Network Working Group, R. Harrison, Novell, Inc., June 2006; RFC 4514, “LDAP: String Representation of Distinguished Names,” Network Working Group, K. Zeilenga, OpenLDAP Foundation, June 2006; RFC 4515, “LDAP: String Representation of Search Filters,” Network Working Group, M. Smith, Pearl Crescent, LLC and T. Howes, Opsware, Inc., June 2006; RFC 4516, “LDAP: Uniform Resource Locator,” Network Working Group, M. Smith, Pearl Crescent, LLC and T. Howes, Opsware, Inc., June 2006; RFC 4517, “LDAP: Syntaxes and Matching Rules,” Network Working Group, S. Legg, eB2Bcom, June 2006; RFC 4518, “LDAP: Internationalized String Preparation,” Network Working Group, K. Zeilenga, OpenLDAP Foundation, June 2006; and RFC 4519, “LDAP: Schema for User Applications,” Network Working Group, A. Sciberras, eB2Bcom, June 2006, the entire contents of each of which are incorporated herein by reference.

Director devices may integrate full LDAP credential information in a hierarchal, top-down method. Once configured, users, credentials, demographic information, groups and share definitions are read on a policy configurable refresh rate. Director devices may then process this information into the director's own security system. Users are typically not deleted, but instead deactivated to provide historical tracking when they still have files resident. Shares may be mapped to appropriate users, and groups may be utilized in administrative menus and uses. Endpoint devices may be allowed access in this mode with valid LDAP credential verification at the endpoint, and denied otherwise. The end result is that when configured for LDAP, director devices function in concert with the organization's LDAP system. Maintenance is also minimized such that users, shares, etc. are still done at the normal LDAP system administration entry point.

In some examples, information object management module 102 further provides an explorer application for enabling a virtual view of files and e-mails residing in a database driven architecture, stored within storage media 132. Virtual representation may be dynamic to the users regardless of where data is stored in director device 14 or archive files, e.g., stored by director archive 6. The explorer application may provide intelligent folder creation by which files and e-mails may be displayed in intelligent folders, where the contents of a folder may be automatically organized and controlled via user-determined policies. Within the intelligent folder, data, including metadata and content may be controlled via policy to enforce actions when data is added, updated, deleted to/from the folder. Intelligent folders may also be created via personal credentials as private, shared, or global in scope.

The explorer application may also provide personal disaster recovery by enabling users to have the ability to restore files and e-mails dynamically for any attached device that supports file storage or archiving. In this manner, the explorer program may provide full e-mail message box recovery between like and dislike e-mail servers. The explorer program may further provide unstructured data presentation, including the ability to render unstructured data content in a virtual three-dimensional, first-person experience. Furthermore, the explorer program may provide an LDAP group representation, in which active directory LDAP groups and shares may be represented dynamically by folder according to security groups via user profiles and shared folders. The explorer allows a dynamic, virtual presentation of a user's created objects. This can be presented in traditional operating system (OS) format, or even in a three-dimensional, first person experience, using modern gaming engines, for example. Presentation of the data may be based on stored content to suite the user, application and/or operating system.

LDAP folders may be presented in the explorer in a “Shared” folder at the user's root directory level. Each group may then be represented within that shared folder. Within each group, specific shares can be displayed. Files within shares can be displayed dynamically. All these items are controlled via policy. The explorer can also display Keyword Alert Folders based upon keyword conditions triggering file entries. Each folder is dynamically created when a keyword alert condition is met. A global Keyword base folder is at the Explorer root. A category for the alert creates the next level folder, and finally, the alert action definition creates the detailed folder. Within this final folder is the alert item created by a user that met the keyword alert condition, as if it was created by the recipient themselves.

In some examples, the explorer application can optionally be presented as a 3D, first person interactive environment. Since the entire director device, vault director device and accelerator devices present a view of how user endpoint systems expect to see files, they are also capable of presenting the user's data in a completely different plane. Users may invoke the themed 3D interfaces that can be loaded from a web browser or directly on the endpoint device as a traditional “fat” client. This 3D, first person interactive environment allows users to move through their file objects, have themed environments, such as a library setting, complete with helpful librarian wizards, or being transported to different environments based upon LDAP defined groups. Files may therefore be literally “handed” to the user and then automatically opened by the endpoints associated file type processor.

For example, after starting the explorer, the user may be presented with an entrance to a gothic library at the door. Using controls used in today's first person interactive gaming world, the user may enter the building and met by a character who asks the user for what he or she desires. Using the wizard theme, a search request maybe entered in a wizard's potion book. Upon pressing a find button on the book, the files, folders, and other documents suddenly fly at the user and hover in mid-air around him. Turning and touching the files, previews open. Grabbing makes them now freeze the 3D experience and that file type association in the native OS calls the hosting application and the file is loaded. Themes can range from amusement parks to outer space, whereby the experience can be actually fun to work with, not to mention more tactile.

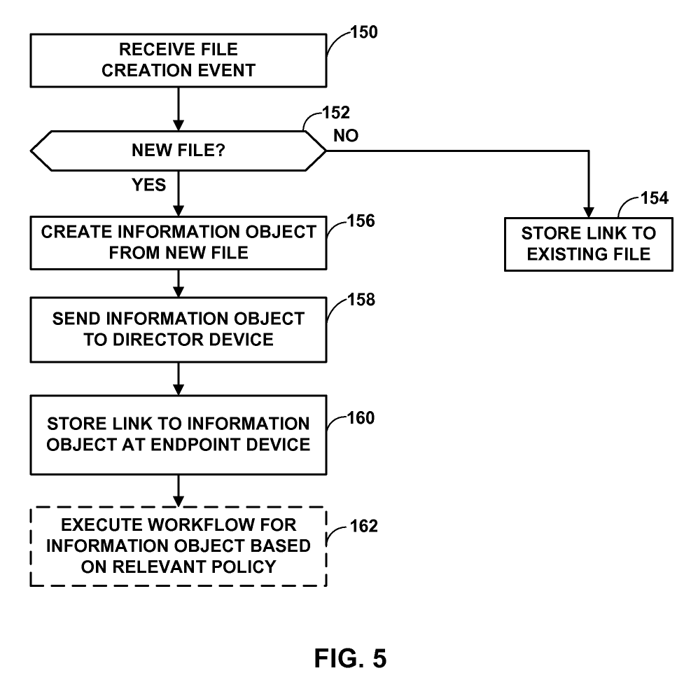

FIG. 5 is a flowchart illustrating an example process for storing an information object by an endpoint device, such as endpoint device 50. In particular, performance of the method of FIG. 5 may result in either storing a new information object or storing a link to an existing information object by an endpoint device. Although described with respect to endpoint device 50 for purposes of example, any of endpoint devices 10 may perform the method of FIG. 5 when storing a file.

Initially, file detection module 64 detects a file creation event (50). A file creation event may comprise, for example, a file save event, a file close event, a file save and close event, or other event at the operating system level that would result in the creation of a new file. File detection module 64 may then send a signal to file management module 74 that a file creation event has been detected. File management module 74, in turn, may generate a file signature by executing one or more hash functions on the created file. In some examples, policy enforcement module 68 may make a preliminary policy check to ensure that the user is authorized to store the file before the file signature is generated. While the endpoint device is not connected to the user's networked environment, file changes, additions, and other modifications may be automatically sensed and processed when the endpoint agent senses a reconnection.

File management module 74 may then send the file signature to a director device, such as director device 14, to determine whether the created file is new relative to files stored by director device 14 (152). When director device 14 determines that the file signature matches an existing file signature stored by director device 14, director device 14 sends a signal to endpoint device 50 that the file is not new (“NO” branch of 152). Accordingly, rather than storing the file to director device 14, endpoint device 50 stores a link to the existing file stored by director device 14 (154). In general, endpoint device 50 is configured to cause the link to appear to a user of endpoint device 50 as if the file is actually stored in the location where the user attempted to store the file. Even though a director device may determine that a file is already resident, an information object (file pointer and metadata) for that new requesting user is created, thus eliminating file duplication physically, but enabling user access originality and track-ability. Policies can then be individually be invoked for users if desired, as opposed to just the file.

For example, assuming that a user attempted to store a PDF file of an employee handbook entitled “Handbook.pdf” in a directory entitled “Documents/Corporate/,” but the file “Handbook.pdf” was already stored by director device 14, endpoint device 50 would generate a link entitled “Handbook.pdf” in the directory “Documents/Corporate/” that appeared to the user as if the PDF document were in fact stored in ““Documents/Corporate/.” However, when the user attempts to open the file “Handbook.pdf,” endpoint device 50 would use the link to retrieve the file from director device 14. Alternatively, the file may actually reside on “Documents/Corporate” but the File Management Module may manage where to open the file via a closest file first algorithm. This may be local, at director device 14, or at director archive 6.

On the other hand, when director device 14 determines that the file signature does not match an existing file signature stored by director device 14, director device 14 sends a signal to endpoint device 50 that the file is new (“YES” branch of 152). Accordingly, information object creation module 66 may create an information object from the new file (156). Information object creation module 66 may retrieve metadata from metadata repository module 72, such as, for example, an identifier of the user who created the file and an identifier of endpoint device 50, that is, an identifier of the computing device that was used to create the file. Information object creation module 66 may also determine the file type for the new information object according to an extension for the saved file name, a program that was used to create or save the file, or other file type detection methods. Information object creation module may then encode the user identifier, the file type, the computing device identifier, and other metadata (such as, for example, the date and time that the information object was created) into the information object for the file.

Information object creation module 66 may also determine one or more policies for the file based on, for example, the file type, the user who created the file, the computing device identifier, or other factors. Information object creation module 66 may then encode the information object with policy data indicative of the policies for the information object. For example, the policies may specify that the file be undeletable for a period of time following creation of the file, who can access or cannot access the file, where the file may be stored, and/or whether files of this type are currently subject to a legal hold. Information object creation module 66 may encode policy data into the new information object to reflect these or other policies for the information object.

Information object creation module 66 may then send the information object to director device 14 for storage via network interface card 80 (158). Information object creation module 66 may also store a link to the information object in a directory at which the user attempted to store the file (160), such that the link appears to the user as if the file is stored in the directory. When endpoint device 50 stores a link to the file, director device 14 records that the link has been stored. For example, director device 14 may increment a “linked to” counter, also referred to as a “link counter,” associated with the file when a link is stored by endpoint device 50 to the file. When a user stores a link to the file, director device 14 may increment the link counter (that is, set the link counter equal to one more than the previous value of the link counter), and when a user deletes a link to the file, director device 14 may decrement the link counter (that is, set the link counter equal to one less than the previous value of the link counter). In this manner, director device 14 may determine how many links to the file exist. Director device may store the counter as metadata with the information object that includes the file.

Director device 14 may maintain counters for all versions of a file based upon file name, create/modification dates, user ID, and optionally by directory and machine. Further versions numbers are also maintained at director device 14, in some examples, for group versions which mimic the individual versions, for which director device 14 may automatically blend in multiple editors or users. This versioning may be based on file name, creation/modification date, user ID, and/or directory share name. Version numbers may be incremented to the next version number based upon a last in policy. The max number of versions retained may be driven by policy configuration at director device 14. Overrides can be created by user, file type, group or any combination thereof. Additionally, versions of files can also be maintained at off-site director archive 6. If only one version is configured to be resident at director archive 6, the latest file may always be maintained there. When a new version is moved to director archive 6, it may first be written and verified to be intact, e.g., using a checksum. After this verification, the earlier version may automatically be removed.

In addition, based on a policy for the information object, endpoint device 50 may begin to execute a workflow for the information object (162). Not all policies specify the execution of a workflow, therefore block 162 is shown with a dashed outline to depict this step as being optional. Workflows are triggered by a “File Type Handler” which is a unique set of code defining action to be taken when a specific file type is executed by an endpoint device. When a policy specifies that a workflow execution is to begin, endpoint device 50 may execute one or more of applications 52 to perform the workflow. An administrator may implement any desired workflow for a policy that is automatically executed when a file corresponding to the policy is stored. Administrators can preselect “File Type Handlers” from a predefined set in the Administrative Engine, or they can write unique “File Type Handlers” for specific workflow applications.

When a file is enrolled in the director device from an endpoint, its meta data wrapper is paired with the file to become an information object. This object now has intelligence that allows it to be dynamically picked up by defined after enrollment actions and workflows. Administrators define these workflow actions using a director web-based user interface. This configuration utilizes a wizard-based approach that extends the normal file handler metaphor. While some files may or may not be processed for content indexing and individual file processing, a global condition is configured for workflow actions. All enrolled files (and their pointer references, for deduplicated additional users/locations) are qualified against the defined master condition logic.

Administrators set up a master workflow definition. This definition then utilizes predefined or new condition tests. Condition tests utilize any and all file information and meta information to test if a file meets a defined condition. For files that meet this condition, condition actions are defined that specify what actions to take. Certain default actions can be merely selected, such as email notices, explorer folder creation items. User extendable operations can also be defined or added. These definitions can be internal or external processing directives that are up to the administrator to create. The interface provides a manner to create master definitions, condition tests and action definitions. These workflow setups can then be simply configured via quick, line item type entries.

Director device 14 may also be configured to execute and respond to “keyword alerts.” An administrator may configure policies at director device 14 that allow for instant recognition and notification/workflow actions to be taken when created content is stored. Director device 14 may allow for infinite definition of keyword actions (e.g., what to do when a condition is reached), infinite definition of keyword categories (e.g., the grouping by major category of detection), infinite keyword condition definition (if this but not this, etc.) and infinite keyword alerts. The keyword alert may be directed to keywords within a file or metadata that describes the file.

For example, an organization may by default have four categories defined: Human Resources—Behavior, Human Resources—Harassment, External Compliance, and Customer Satisfaction. A sales manager may want to be sure a certain customer is treated with respect, so the sales manager may define a keyword alert policy at director device 14 that instantly notifies him of any and all files or emails in his sales area pertaining to that customer, all automatically. When an email arrives from that customer directed to a sales representative, and there is a keyword match, that manager may be instantly notified via an alert email as well as having that exact email information object being placed in that managers data directory. The manager may then merely navigate to a new “Customer Satisfaction” folder that further subdivides items by, for example, customer, then sales representative. In that folder, director device 14 may automatically include any and all objects that meet that keyword alert condition.

As another example, a school may provide login credentials for all its students. A school administrator may define a policy that uses keyword alerts to recognize, for example, a “hit list” profile. If a student were to create a “hit list” matching the profile, director device 14 may, the instant that file is created, notify a school compliance officer and generate a virtual file pointer (copy) that is placed in that compliance officer's directory, e.g., in a “Compliance” drive.

As an example, a policy for a brokerage enterprise may specify that the terms “guarantee,” “percent,” and “return” not be in a text document created by a user who is classified as a broker. When these terms appear in a document, the workflow may generate an e-mail identifying the user who created the document, attach the document to the e-mail, and send the e-mail to an administrator and/or the user's supervisor. The workflow may further prevent the e-mail including the terms from being sent outside the brokerage.

As another example, a policy may specify that when a user who is classified as an accountant updates a spreadsheet document classified as an income statement, that the user also update corresponding balance sheet and cash flow spreadsheet documents. Thus endpoint device 50 may automatically load and present the balance sheet and cash flow spreadsheet documents to an accountant user who updates an income statement spreadsheet.

When a new information object is stored to director device 14, director device 14 may also automatically perform certain tasks. For example, keyword management module 120 may search for keywords in a text-based document and associate the keywords with the information object. File signature module 118 may store the file signature for the file data of the information object.

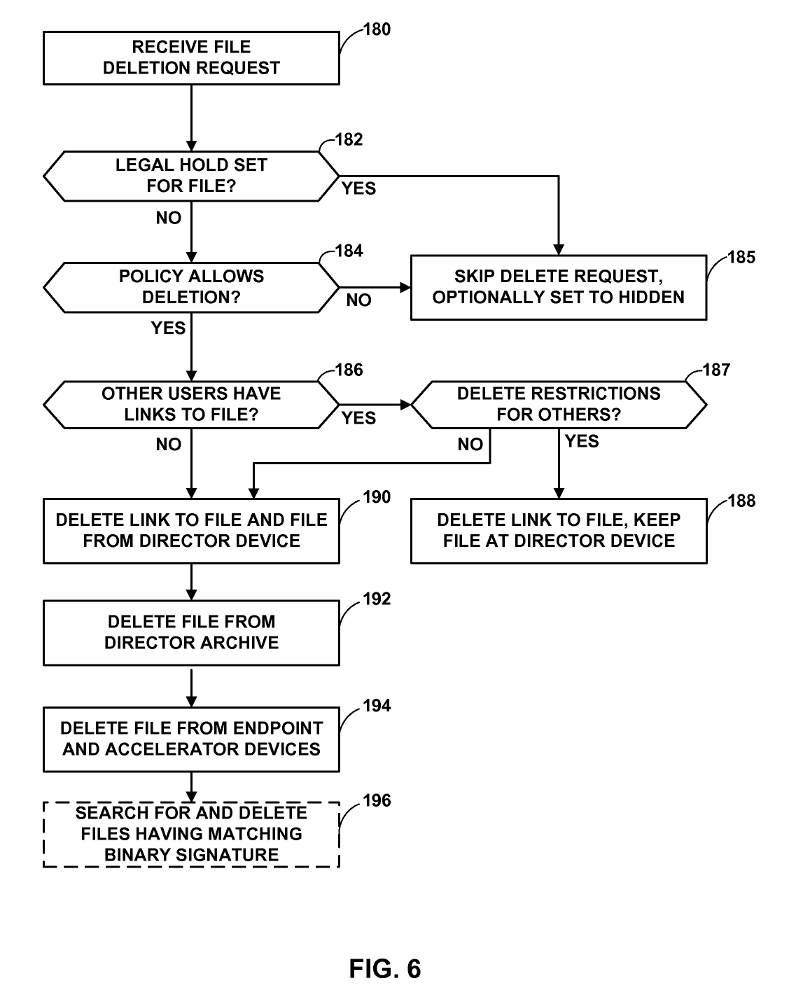

FIG. 6 is a flowchart illustrating an example process for handling delete requests from a user for a particular file. The method of FIG. 6 is described with respect to director device 14 for purposes of explanation and example, although any director device may implement the method of FIG. 6. For example, affiliate director device 8 may implement the method of FIG. 6.

Initially, a user of an endpoint device in communication with director device 14 requests to delete a particular file. Information object retrieval module 104 may receive the request and determine the file specified by the deletion request (180). Policy enforcement module 108 may then determine, for the specified file, whether a legal hold is set for the file (182) and whether the policy for the file permits the file to be deleted (184). For example, the policy may specify that a file may not be deleted until a period of time from the creation date or the last modification date as specified by the policy has passed. When a legal hold is set for the file (“YES” branch of 182) or when the policy does not allow for deletion (“NO” branch of 184), director device 14 may skip the delete request, and optionally set the file as hidden on the endpoint device requesting the deletion (185).

As discussed above, director device 14 may also maintain a counter associated with an information object to determine how many links to the information object exist. Accordingly, when a legal hold for the file is not set (“NO” branch of 182), and the policy for the file permits deletion (“YES” branch of 184), director device 14 also determines whether any other links to the file exist (186) before deleting the file. In this manner, director device 14 may avoid deleting a file for which at least one user has a link.

After determining that a legal hold is not set for a file (“NO” branch of 182) and that the policy allows for deletion (“YES” branch of 184), director device may determine whether there are deletion restrictions for other users (187). When a deletion restriction is present for a user (“YES” branch of 187), the endpoint device may delete the link to the file, but director device 14 may continue to store the file. On the other hand, when there is no legal hold for the file (“NO” branch of 182), the policy allows for deletion of the file (“YES” branch of 184), and no other user has a link to the file (“NO” branch of 186), or when there is no deletion restriction for other users (“NO” branch of 187), the endpoint device may delete the link to the file, and director device 14 may delete the file (190). Director archive 6 also deletes the file (192) In addition, endpoint devices and accelerator devices currently storing the file may delete the file (194). Optionally, director device 14 may institute a “search and destroy” procedure, whereby director device 14 may distribute a binary signature of the file to devices of system 2, and require that the devices search for files matching the binary signature and delete those files that match the signature (196).

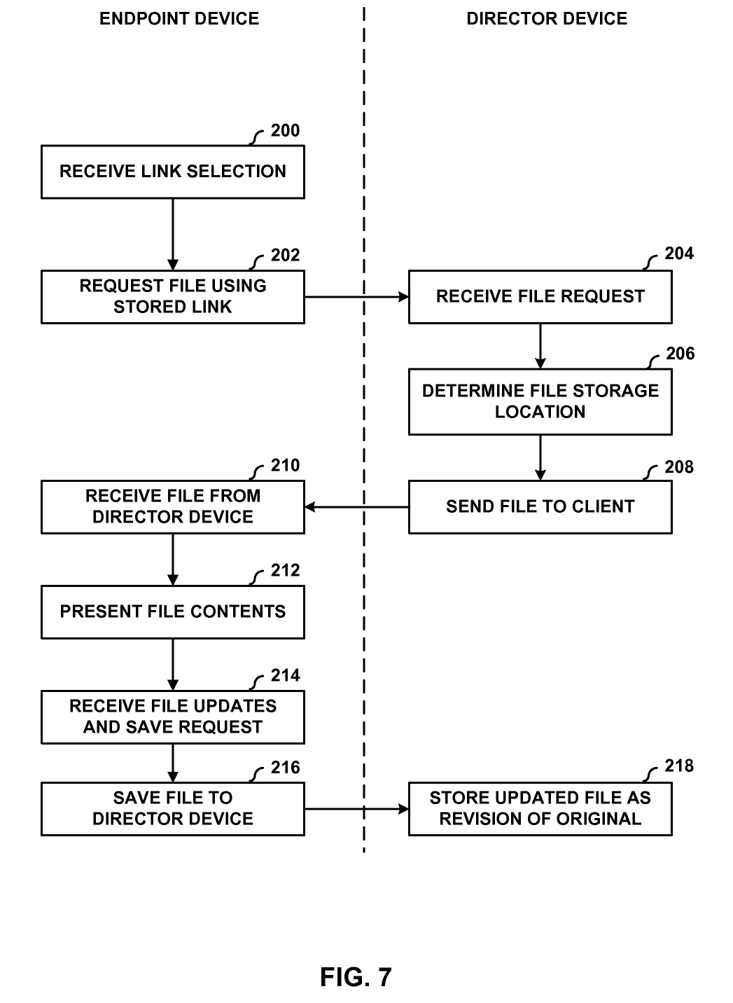

FIG. 7 is a flowchart illustrating an example process for an endpoint device to open and update a file stored by a director device. The method of FIG. 7 is described for purposes of example and explanation with respect to endpoint device 50 and director device 14. However, any of endpoint devices 10 may perform the method of FIG. 7 to open and update a file.

Initially, a user may execute one of applications 52 to open a file stored by director device 14 (200). The user may select the link directly, which may open an affiliated one of applications 52 automatically, or the user may open the link through a browser of one of applications 52. In either case, file management module 74 receives the link selection. File management module 74 may utilize the link to the file to generate a request for file data and send the request to director device 14 (202). Policy enforcement module 68 may first verify that the user has the right to access the requested file.

When director device 14 receives the request for the file data (204), information object retrieval module 104 may determine where the information object containing the file data is stored (206), e.g., within storage media 132 (FIG. 4). That is, information object retrieval module 104 may determine which of a plurality of hard drives or other storage media of director device 14 is currently storing the file. Information object retrieval module 104 may also determine whether affiliate director device 8 is currently storing the file data, when the file data is not stored within storage media 132. After identifying the information object containing the file data, information object retrieval module 104 may send the information object including the file data to endpoint device 50 (208). Before sending the information object, policy enforcement module 106 may perform an additional or alternative policy verification with respect to the user to ensure that the user is permitted to access the file.

After receiving the file data from director device 14 (210), endpoint device 50 may present the file contents to the user who requested access to the file (212). For example, endpoint device 50 may execute one of applications 52 that corresponds to the file type for the file. In some examples, the user may simply close the file without making modifications. However, the example of FIG. 7 assumes that the user has opened the file to make modifications or updates to the file. Therefore, using the one of applications 52 in which the file data was presented, the user may modify the file data (214). Ultimately, the user may save the updated file. When files are accessed by an endpoint from a local storage location or a director device, file access metadata is updated at director device 14 so that user reads are accounted for. Practical uses of this meta information may include deletion condition control. If an organization has reference PDF files, for example, that aren't updated but are accessed regularly, director device 14 may be configured to avoid automatically deleting the files by origination date expiration only.

File detection module 64 may detect the save and/or close event following the user's modifications to the file. In some examples, file detection module 64 may verify that the updated file does not exist within director device 14 by generating a file signature and sending the file signature to director device 14 as described with respect to FIG. 5. In any case, file management module 74 determines that the user made updates to an existing file of director device 14. Therefore, when file management module 74 sends the updated file to director device 14 for storage (216), the updated file is stored as a revision of the original or previous version of the file (218).

In this manner, when director device 14 subsequently receives a request for the file from, e.g., a different one of endpoint devices 10 using a link to the original file, director device 14 instead provides the one of endpoint devices 10 with the updated file, rather than the original file. In some examples, a user may request to view all revisions of a file, e.g., by selecting the link to the file and opening a menu, e.g., by right-clicking the link, and selecting a desired revision. Director device 14 may provide data indicative of the number of revisions of a file stored by director device 14, when each revision was made and by whom, or other revision data.

In some examples, director device 14 may store all revisions of a file, while in other examples, director device 14 may be configured to store only a certain number of revisions, e.g., in a first-in-first-out procedure. For example, director device 14 may be configured to store only the latest three revisions of a file. In some examples, a revision is only stored when a user saves a document and then closes the document, to avoid automatic saves of the document wiping out all other revisions of the document in one editing session.

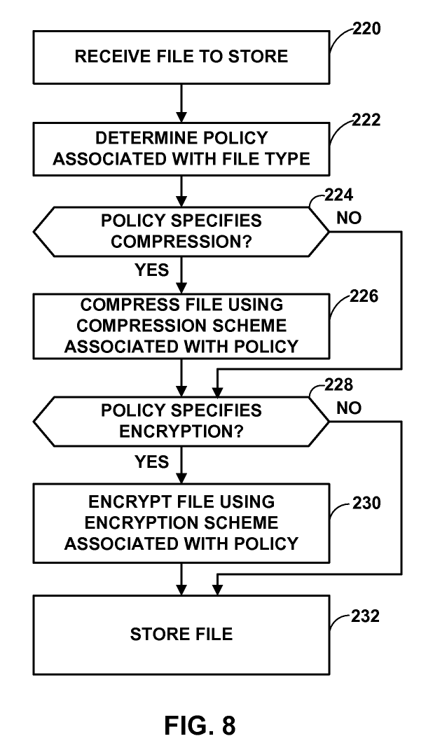

FIG. 8 is a flowchart illustrating an example process for performing either or both of encryption and compression by a director device after a new file has been stored. Director device 14 may be configured to perform the method of FIG. 8 after a file has been stored according to the method of FIG. 5. Initially, director device 14 receives a file to be stored (220). Director device 14 determines a policy associated with the file, e.g., according to the file type of the file (222). The policy may be specified in policy data of an information object including the file data, or director device 14 may modify or update the policy data of the information object when the information object is received. Files can optionally be compressed by an algorithm for that file type by policy configuration. For example, JPG files are generally better compressed with a loss-less encryption routine, while text files can benefit from another. This choice is policy driven and configured by file type in the administrative console.

In any case, director device may determine whether the policy requires that the file be compressed (224). When the policy specifies that the file is to be compressed (“YES” branch of 224), compression module 110 determines whether a particular compression scheme is specified by the policy. For example, a policy may specify that a text document be compressed into a ZIP file format, using a run-length encoder, or using any other appropriate lossless compression algorithm. As another example, a policy may specify that image documents and/or video documents be compressed using, for example, a lossy compression algorithm. Compression module 110 may then compress the file using an appropriate compression algorithm that satisfies the policy (226).

Whether or not the file is compressed, director device 14 may also determine whether the policy requires that the file be encrypted (228). When the policy specifies that the file is to be encrypted (“YES” branch of 228), encryption module 108 determines whether a particular encryption scheme is specified by the policy. For example, certain policies may simply specify that a file be encrypted by any means, while other policies may specify a specific encryption scheme for a file. Encryption module 108 may also use a particular key as specified by the policy. For example, the policy may specify the use of a one-time password to encrypt the document, a key that corresponds to a current time period (e.g., a thirty day window), a specific public key, or other specific key. Encryption module 108 may then encrypt the file using an appropriate encryption algorithm and key that satisfy the policy (230). Director device 14 may then store the file (232).

In various examples, director device 14 may store the file locally within director device 14, to director archive 6, or both. In some examples, director archive 14 may automatically deduplicate the file from devices of system 2, compress and/or encrypt the file, then store the compressed and/or encrypted version of the file to director archive 6. Following storage, the file is accessible to the endpoint device that stored the file. Files may also optionally be configured to be processed with an anti-virus scan before storage in director archive 14 and/or director archive 6. This can be done at the director device, accelerator, or endpoint. Policy directives dictate which level should invoke the virus scan and details.

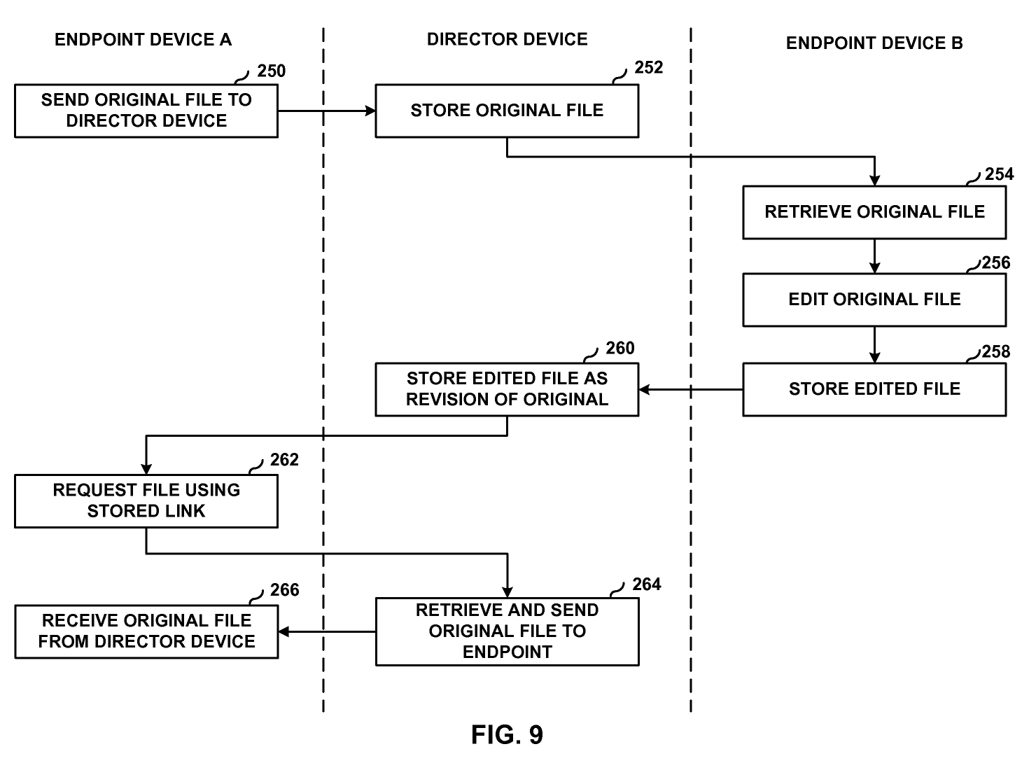

FIG. 9 is flowchart illustrating an example method of file revision control for system 2. Various policies may be configured for revision control, as discussed below, and FIG. 9 is one example policy that may be used by default. In general, the method of FIG. 9 is directed to a method in which when a user revises a file, the user's personal link to the file is directed to the revised file, but other users' links are directed to the original file (assuming those users have not themselves revised the original file). In other examples, a policy for the file may cause links to the file to be automatically updated to be directed to the revised file. In some examples, the policy may cause links to be automatically updated when a particular user updates the file, and prevent other users from saving any updates to the file, unless those updates are saved with a separate link. In still other examples, a plurality of users may be part of a group, and when any member of the group revises the file, the other members' links are automatically updated to be directed to the revised file, whereas any other users who are not part of the group and have links to the file would not have their links automatically updated.

In the example of FIG. 9, a user of one of endpoint devices 10 (labeled “endpoint device A” in FIG. 9) sends an original document to director device 14 for storage (250), after which director device 14 may store the file (252), e.g., as an information object. Although not shown for purposes of brevity, endpoint device A may also store a link to the file, e.g., as described with respect to FIG. 5. Likewise, endpoint device A may first form an information object comprising the file and send the information object to be stored within director device 14.

Also not shown for the purpose of brevity is that endpoint device B stores a link to the original file. After the original file is stored, and after storing a link to the file, a user of endpoint device B retrieves the original file from director device 14 (254). The user may then edit the original file (256) and store the edited file back to director device 14 (258).

Rather than overwriting the original file, however, director device 14 may store the edited file as a revision of the original file (260). The link to the file stored by endpoint device B need not be changed, but may automatically be directed by director device 14 to the revised file. Director device 14, and/or endpoint device B, may be configured to update metadata of the revised file to reflect that the revised file is owned by the user of endpoint device B. Similarly, director device 14 may update metadata of the revised file to indicate that the revised file is related to, and a revision of, the original file. In this manner, the user of endpoint device B may later select the link to the file, and upon selecting the link, endpoint device B may permit the user of endpoint device B to open either the revised file or the original file. Moreover, endpoint device B may depict any other revisions of the file that are available to the user of endpoint device B.

On the other hand, the links for other users, in the example of FIG. 9, would continue to be directed to the original file. For example, as shown in FIG. 9, the user of endpoint device A may subsequently request to access the file using the stored link (262). Accordingly, director device 14 may retrieve and send the original file to endpoint device A (264), in response to which, endpoint device A may receive the original file (266) and present the original file to the user of endpoint device A. If the user of endpoint device A were to edit the original file, director device 14 may store a separate revision of the file, such that if the user of endpoint device A were to request the file, director device 14 would send the revision specific to endpoint device A, whereas if the user of endpoint device B were to request the file, director device B would send the revision specific to endpoint device B.

FIG. 9 provides one example method for storing and retrieving files. In some examples, files may additionally be stored locally within endpoint devices A and/or B, and/or within director archive 6. In some examples, an “open closest file first” algorithm causes director device 14 to first determine whether endpoint device A or endpoint device B is currently storing the file, and if either of these endpoint devices is storing the file, director device 14 may cause endpoint device A to retrieve the file from the one of the endpoint devices storing the file. Likewise, if the file has been removed from local storage of director device 14, director device 14 may retrieve the file from director archive 6, decompress and/or decrypt the file, and then provide the file to endpoint device A.

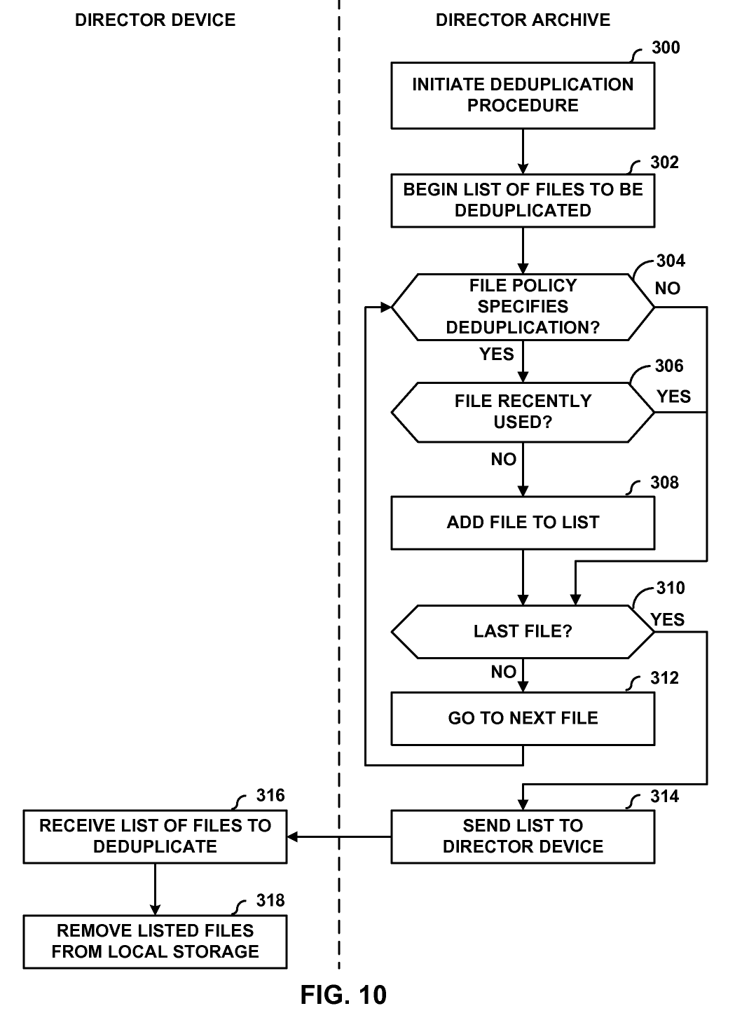

FIG. 10 is a flowchart illustrating an example deduplication procedure between director archive 6 and director device 14. Director archive 6 may also interact with other director devices, such as affiliate director device 8, to perform the deduplication procedure. In the example of FIG. 10, director archive 6 is configured to initiate a deduplication procedure (300). For example, director archive 6 may be configured to periodically initiate the deduplication procedure, e.g., once every thirty days, or in response to a request from an authorized user, such as an administrator. In other examples, director device 14 may instead initiate the deduplication procedure, determine whether a particular file should be deduplicated, verify that director device 6 is storing a copy of the file, and then delete the file.

After initiating the deduplication procedure, director archive 6 begins a list of files to be deduplicated (302). The list may comprise file signatures for files to be deleted from local storage of each of the director devices coupled to director archive 6, such as director device 14. In other examples, the list may comprise other indications, such as, for example, listing file names or query-like expressions of files to be removed from local storage of the director devices. For example, director archive 6 may specify that all audio and video files are to be removed from local storage of the director devices. As another example, director archive 6 may specify that all text documents that are affiliated with a particular keyword are to be removed from local storage of the director devices. In still another example, director archive 6 may specify that all documents created before a specific date are to be removed from local storage of the director devices. Director archive 6 may, similarly, use these or other criteria in determining which files to specify in the list of files to be deduplicated, as described in the example of FIG. 10.

Beginning with a first archived file, stored by director archive 6, director device 14 determines whether a policy for the file specifies that the file should be deduplicated (304). The file policy may specify, for example, that a file is to be deduplicated when the file has not been accessed within a particular time period, when the file is subject to a legal hold, when the time for retention specified by the file has passed, when no links to the file exist on any of endpoint devices 10, or other criteria. Director archive 6 and director device 14 coordinate efforts, in some examples, to ensure that files are always deduplicated. For example, from the moment files are created at endpoint device 50, director device 14 may be queried as to whether or not to an object is unique. Retention, revisions, offsite archiving may all be determined at this level.

When the file policy does not currently specify that the file should be deduplicated (“NO” branch of 304), director archive 6 skips the file and moves to a next file, if there is a next file available. On the other hand, when the file policy does specify that the file should be deduplicated (“YES” branch of 304), director archive 6 may determine whether the file has been recently used (306). In the example of FIG. 10, director archive 6 deduplicates files that have not been recently used, while avoiding deduplication of files that have been recently used. In other examples, director archive 6 may deduplicate files even when they have been recently used, and/or may skip deduplication of files only when the files are currently in use.

The policy for the file may define how recent a file may have been used before director archive 6 determines that a file was “recently used.” Therefore, different policies may define “recently used” differently. For example, a policy for text documents may specify that a text document is recently used if it was opened within thirty days, whereas a policy for image files may specify that an image file is recently used if it was opened within ninety days. In general, an administrator or other authorized user may configure policies to define “recently used” for the policies in any desired manner.

When the file has not been recently used (“NO” branch of 306), director archive 6 may add the file to the list of files to be deduplicated (308). On the other hand, when the file has been recently used (“YES” branch of 306), director archive 6 may skip the file and determine whether the file is the last file that could be deduplicated (310). If additional files remain (“NO” branch of 310), director archive 6 may go to the next file (312) and check whether the next file should be deduplicated.

On the other hand, when no more files remain to check (“YES” branch of 310), director archive 6 may send the list of files to be deduplicated to director device 14 (314). Similarly, director archive 6 may send the list to each director device coupled to director archive 6, e.g., by also sending the list to affiliate director device 8. In some examples, director archive 6 may also send the list to endpoint devices 10 that are permitted to store files locally. In some examples, director archive 6 may prepare individual lists for each director device, and in other examples, director archive 6 may prepare a single list for all director devices. The director devices, such as director device 14, may receive the list of files to be deduplicated (316) and remove files from local storage that are identified by the list (318). When the list is specific to the director device, the director device may locate and remove all files on the list. When the list is a generic list created for all director devices, the director device may determine which files in the list are locally stored and then delete those files from local storage.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described herein may also be embodied in a computer-readable medium, such as a computer-readable storage medium, containing instructions. Instructions embedded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. Actions that are described as being performed by a director may also be performed by any general computing device, such as, for example, an endpoint device, an accelerator device, a server device, a client device, a workstation, a database server, an e-mail server, a director archive, or other device. Likewise, actions that are described as being performed by an endpoint device may also be performed by any general computing device. These and other examples are within the scope of the following claims.

1. A method comprising:
determining, by a computing device, a time of retention for a file specified by a policy associated with the file;
receiving a request to delete the file; and
deleting the file in response to the request only after the time of retention for the file specified by the policy has passed.

2. The method of claim 1, further comprising calculating the time of retention based on a time when the file was created.

3. The method of claim 1, further comprising calculating the time of retention based on a time when the file was stored to the computing device.

4. The method of claim 1, further comprising receiving an indication that the file is subject to a legal hold, wherein deleting the file comprises deleting the file only after the time of retention for the file has passed and after the legal hold has been removed.

5. The method of claim 4, further comprising receiving an indication that the legal hold has been removed for the file.

6. The method of claim 1, further comprising tracking a number of users who have stored links to the file, wherein deleting the file comprises deleting the file only after the time of retention for the file has passed and after the number of users who have stored links to the file is equal to zero.

7. The method of claim 6, wherein tracking the number of users who have stored links to the file comprises:
incrementing a link counter when one of the users stores a link to the file; and
decrementing the link counter when one of the users deletes a link to the file.

8. A device comprising:
a computer-readable medium configured to store a file; and
a processing unit configured to determine a time of retention for the file specified by a policy associated with the file, receive a request to delete the file, and delete the file in response to the request only after the time of retention for the file specified by the policy has passed.

9. The device of claim 8, wherein the processing unit is configured to calculate the time of retention based on a time when the file was created.

10. The device of claim 8, wherein the processing unit is configured to calculate the time of retention based on a time when the file was stored to the computer-readable medium.

11. The device of claim 8, wherein the processing unit is configured to receive an indication that the file is subject to a legal hold, and wherein the processing unit is configured to delete the file only after the time of retention for the file has passed and after the legal hold has been removed.

12. The device of claim 11, wherein the processing unit is configured to receive an indication that the legal hold has been removed for the file.

13. The device of claim 8, wherein the processing unit is configured to track a number of users who have stored links to the file, and wherein the processor is configured to delete the file only after the time of retention for the file has passed and after the number of users who have stored links to the file is equal to zero.

14. The device of claim 13, wherein to track the number of users who have stored links to the file, the processing unit is configured to increment a link counter when one of the users stores a link to the file and to decrement the link counter when one of the users deletes a link to the file.

15. A system comprising:
a plurality of endpoint devices; and
a director device configured to determine a time of retention for a file specified by a policy associated with the file, wherein the file is stored by the director device, receive a request to delete the file from one of the plurality of endpoint devices, and delete the file in response to the request only after the time of retention for the file specified by the policy has passed.

16. The system of claim 15, wherein the director device is configured to calculate the time of retention based on a time when the file was created.

17. The system of claim 15, wherein the director device is configured to calculate the time of retention based on a time when the file was stored to the computing device.

18. The system of claim 15, wherein the director device is configured to receive an indication that the file is subject to a legal hold, and wherein the director device is configured to delete the file only after the time of retention for the file has passed and after the legal hold has been removed.

19. The system of claim 18, wherein the director device is configured to receive an indication that the legal hold has been removed for the file.

20. The system of claim 15, wherein the director device is configured to track a number of users of the plurality of endpoint devices who have stored links to the file, wherein the director device is configured to delete the file only after the time of retention for the file has passed and after the number of users who have stored links to the file is equal to zero.

21. The system of claim 20, wherein to track the number of users who have stored links to the file, the director device is configured to incrementing a link counter when one of the users stores a link to the file and decrement the link counter when one of the users deletes a link to the file.

22. A computer-readable storage medium encoded with instructions that cause a processor to:
determine a time of retention for a file specified by a policy associated with the file;
receive a request to delete the file; and
delete the file in response to the request only after the time of retention for the file specified by the policy has passed.

23. The computer-readable storage medium of claim 22, further comprising instructions that cause the processor to calculate the time of retention based on a time when the file was created.

24. The computer-readable storage medium of claim 22, further comprising instructions that cause the processor to calculate the time of retention based on a time when the file was stored to the computing device.

25. The computer-readable storage medium of claim 22, further comprising instructions that cause the processor to receive an indication that the file is subject to a legal hold, wherein the instructions that cause the processor to delete the file comprise instructions that cause the processor to delete the file only after the time of retention for the file has passed and after the legal hold has been removed.

26. The computer-readable storage medium of claim 25, further comprising instructions that cause the processor to receive an indication that the legal hold has been removed for the file.

27. The computer-readable storage medium of claim 22, further comprising instructions that cause the processor to track a number of users who have stored links to the file, wherein the instructions that cause the processor to delete the file comprise instructions that cause the processor to delete the file only after the time of retention for the file has passed and after the number of users who have stored links to the file is equal to zero.

28. The computer-readable storage medium of claim 27, wherein the instructions that cause the processor to track the number of users who have stored links to the file comprise instructions that cause the processor to:
increment a link counter when one of the users stores a link to the file; and
decrement the link counter when one of the users deletes a link to the file.
